(19) United States
(12) Patent Application Publication
(10) Pub. No.: US 2017/0310510 A1
(43) Pub. Date: Oct. 26, 2017

(54) Q-BASED ZERO-FORCING ADAPTIVE CONTROL

(71) Applicant: FUJITSU LIMITED, Kawasaki-shi (JP)

(72) Inventor: Yasuo HIDAKA, Cupertino, CA (US)

(73) Assignee: FUJITSU LIMITED, Kawasaki-shi (JP)

(21) Appl. No.: 15/138,101

(22) Filed: Apr. 25, 2016

(51) Int. Cl. H04L 25/03

(52) U.S. Cl. CPC H04L 25/03057; H04L 2025/03681; H04L 2025/03808

(57) ABSTRACT

A method of adaptive control is provided. The method may include measuring a first set of average sign values of inter-symbol interference (ISI) of an output signal with a set of control parameters using correlation. The method may further include determining a first set of Q values. The method may also include adjusting the set of control parameters based on the first set of Q values. The method may include measuring a second set of average sign values of ISI using inverted correlation. The method may further include determining a second set of Q values. The method may also include determining a difference between the first set of Q values and the second set of Q values. The method may further include adjusting the set of control parameters based on the difference between the first set of Q values and the second set of Q values. The method may further include adjusting the output signal based on the set of control parameters.

### FIELD

The embodiments discussed herein are related to data signal equalization, and more specifically, to adaptive equalizer control for communication systems.

### BACKGROUND

In high-speed electrical communication, a received signal may often be distorted due to frequency-dependent loss, such as for example skin effect and dielectric loss, causing inter-symbol interference (ISI). Equalizers may be used to compensate for ISI to increase maximal channel length or increase communication speed.

The subject matter claimed herein is not limited to embodiments that solve any disadvantages or that operate only in environments such as those described above. Rather, this background is only provided to illustrate one example technology area where at least one embodiment described herein may be practiced.

### SUMMARY

At least one embodiment of the present disclosure may include a method of adaptive control. The method may include measuring a first set of average sign values of inter-symbol interference (ISI) for non-inverted correlation. The method may further include determining a first Q value based on the first set of average sign values. The method may also include measuring a second set of average sign values of ISI for inverted correlation. The method may further include determining a second Q value based on the second set of average sign values. The method may also include determining a difference between the first Q value and the second Q value. The method may further include calculating an adaptation matrix based on the difference between the first Q value and the second Q value. The method may further include adjusting control parameters based on the adaptation matrix. The method may further include equalizing an output based on the control parameters.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 is a system block diagram of an example adaptive control system that includes one or more equalizers;

FIG. 2 is a block diagram representing an example adaptive equalizer control system 200 that may include a linear equalizer (“LE”), a 1-tap decision feedback equalizer (“DFE”), an error detector, and an equalizer-control logic;

FIG. 3A illustrates an example pulse response of an example transmission channel;

FIG. 3B illustrates two example filter patterns H and L for detecting ISI at 1.5 UIs of delay (h_{+1.5}).

FIG. 3C illustrates example detection of ISI based on one or more error-value differences between two filter patterns;

FIG. 4A illustrates two example minimum filter patterns Hₘ and Lₘ for detecting ISI at 1.5 UIs of delay (h_{+1.5});

FIG. 4B illustrates example detection of ISI based on one or more error-value differences between two minimum filter patterns;

FIG. 5 illustrates example equalizer-control logic using an example Sign-based or Q-based Zero-Forcing method;

FIG. 6 illustrates a block diagram of an example embodiment of an adaptive equalizer controller using extended Sign-based or Q-based Zero-Forcing method;

FIG. 7 illustrates a block diagram of an example embodiment of a filter-pattern decoder;

FIG. 8 illustrates example embodiments of a pair of extended filter-patterns configured to detect long-term ISI;

FIG. 9 illustrates a block diagram of an example adaptive control system that may use a Gradient-Descent algorithm with Q-based Zero-Forcing adaptive control;

FIG. 10 illustrates a block diagram of an example adaptive control system that may use a Gauss-Newton algorithm with Q-based Zero-Forcing adaptive control;

FIGS. 11A-11C illustrates a flow diagram of a method of Q-based Zero-Forcing adaptive control; and

FIG. 12 illustrates a block diagram of an example computer system of adaptive equalizer control, all according to at least one embodiment of the present disclosure.

### DESCRIPTION OF EMBODIMENTS

In high-speed electrical communication, a received signal may be often distorted due to frequency-dependent loss such as skin effect and dielectric loss, which may cause inter-symbol interference (ISI). To compensate for ISI, equalization may be used to counteract effects on the signal. Some equalization techniques may include adapting control parameters, such as equalizer parameters for communication systems, to minimize various metrics of ISI. In at least one embodiment, the control parameters may be adapted to minimize a sum of squares of Q values of average sign values of ISI measured by filter patterns or extended filter patterns.

Some equalization techniques may include measuring an output of a system under adaptation (SUA) and minimizing error in the output. Systems that use Sign-based Zero Forcing (S-ZF) for adaptive control may calculate a sign error vector based on the output. S-ZF systems may use an adaptation matrix to weigh the error in the output to minimize. An advantage of S-ZF is that once an adaptation matrix is optimized, S-ZF may converge to the same final state as other methods, such as an Analog-based Zero Forcing (A-ZF) method, using only sign error value (no analog error value). Without the analog error value, however, the adaptation matrix of S-ZF may be difficult to optimize because optimization typically uses analog error value. Thus, the adaptation matrix of S-ZF in some current systems is not automatically optimized, and may often be manually optimized instead.

Aspects of the present disclosure may, in some embodiments, address these and other shortcomings of some conventional techniques by providing Q-based Zero-Forcing of adaptive equalizer control for communication systems. In at least one embodiment, instead of using analog error value to optimize the adaptation matrix, techniques described may use a Q value calculated by an inverse error function for average sign values of ISI that may be measured with filter patterns or extended filter patterns. The Q value may be used instead of analog error value during the characterize mode. Further, by using the Q value instead of analog error value, the adaptive equalizer control system may automatically and/or dynamically optimize the adaptation matrix, which is typically not possible with S-ZF without using analog error value. Further, the adaptive equalizer control system may use the Q value to optimize an adaptation matrix for each channel. The Q-based Zero-Forcing of adaptive equalizer control for communication systems may be applicable to any control parameters and filter structure including for any two-dimensional equalizer, any decision feedback equalizer (“DFE”), any LE, such as a continuous-time linear equalizer (“CTLE”), any low-frequency equalizer (“LFE”), among other types of equalizers.

In at least one embodiment in the present disclosure, a method of adaptive control may include measuring a first set of average sign values of inter-symbol interference (ISI) for non-inverted correlation. The method may further include determining a first Q value based on the first set of average sign values. The method may further include measuring a second set of average sign values of ISI for inverted correlation. The method may further include determining a second Q value based on the second set of average sign values. The method may also include determining a difference between the first Q value and the second Q value. The method may further include calculating an adaptation matrix based on the difference between the first Q value and the second Q value. The method may further include adjusting control parameters based on the adaptation matrix. The method may further include equalizing an output based on the control parameters.

Embodiments of the present disclosure are explained with reference to the accompanying drawings.

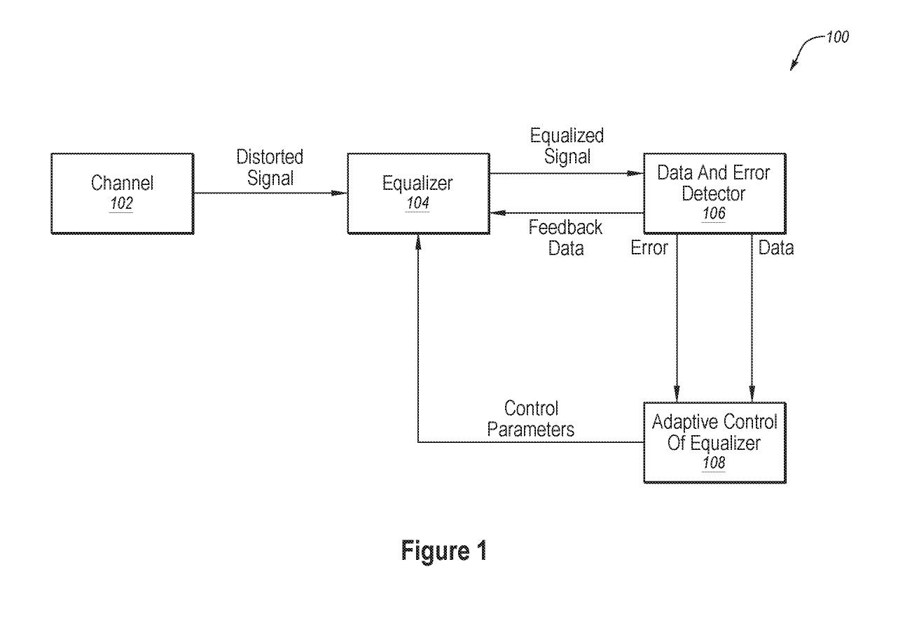

FIG. 1 is a system block diagram of an example adaptive control system 100 that includes one or more equalizers 104. In at least one embodiment, the adaptive control system 100 may include an adaptive equalizer 104 that is communicatively coupled after or before channel 102 or partially after and partially before channel 102.

A channel 102 may be configured to communicate a signal from a transmitter to a receiver. The equalizer 104 may receive the signal. The signal may include some distortion or interference, such as ISI, such that the channel 102 may be configured to transmit the distorted signal with ISI. The equalizer 104 may amplify an attenuated high-frequency component of the received signal to reduce ISI.

The equalizer 104 may be any equalizer configured to reduce ISI and accept control parameters to adjust its operation. For example, the equalizer 104 may be one or more of a continuous-time linear equalizer (CTLE), a decision-feedback equalizer (DFE), a feed-forward equalizer (FFE), or other type or equalizer. The equalizer 104 may be configured to reduce ISI. In some embodiments, the equalizer 104 may be communicatively coupled to a data and error detector 106 and configured to transmit an equalized signal. The data and error detector 106 may be communicatively coupled to the equalizer 104 and configured to transmit a feedback data. For example, a decision-feedback equalizer (DFE) may make feedback to the equalized signal based on the feedback data detected by the data and error detector 106. Alternatively, the equalizer 104 and the data and error detector 106 may be implemented together with in order to tighten a loop of the equalized signal and the feedback data between the equalizer 104 and the data and error detector 106.

The data and error detector 106 may determine data value carried by the equalized signal and error value in relation to ISI of the equalized signal. The data and error detector 106 may be communicatively coupled to an adaptive equalizer controller 108 (i.e., adaptive control of equalizer 108) and may be configured to send the data and error of the equalized signal to the adaptive equalizer controller 108.

The adaptive control of equalizer 108 may be configured to determine control parameters for the operation of the equalizer 104 based on filter pattern matching of the data and error. In some embodiments, the adaptive control of equalizer 108 may use one or more finite state machines to implement filter patterns for detecting short-term ISI and extended filter patterns for detecting long-term ISI.

The adaptive control of equalizer 108 may be configured to use filter patterns and/or extended filter patterns to determine the control parameters for the operation of the equalizer 104 based on filter pattern matching and/or extended filter pattern matching of the data and error. The adaptive equalizer controller 108 may be communicatively coupled to the equalizer 104 to provide the control parameters. The equalizer 104 may be configured to adjust its operation based on the control parameters.

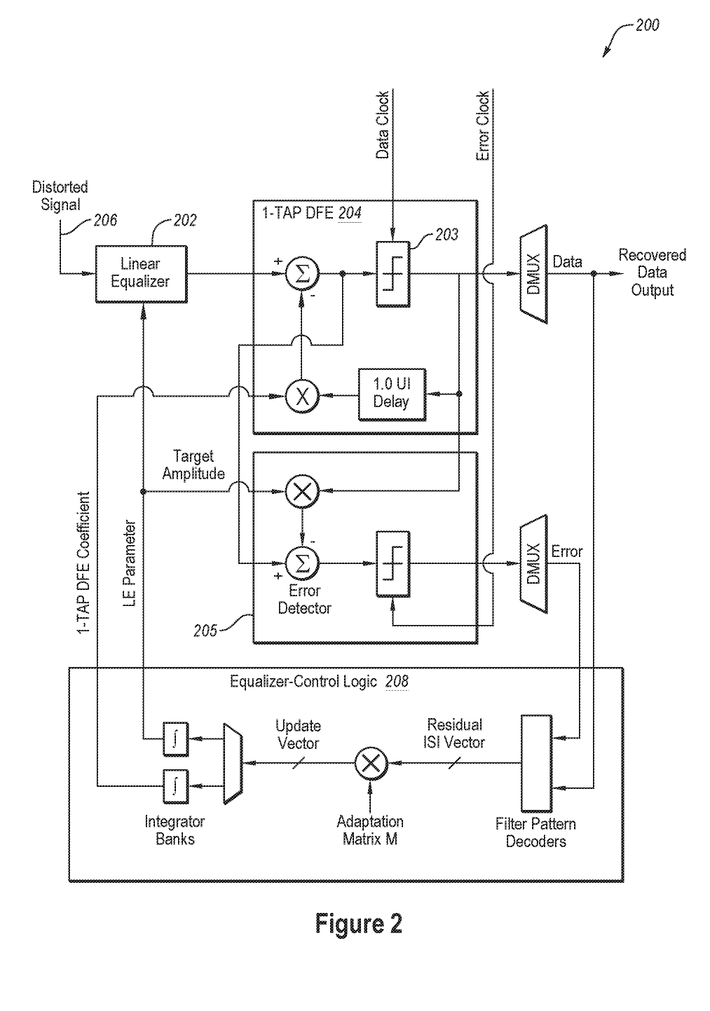

FIG. 2 is a block diagram representing an example adaptive equalizer control system 200. The adaptive equalizer control system 200 may include any equalizer or combination of equalizers for receiving, at an input port 206, a distorted signal from a transmitter through a channel and applying a gain, offset, or other modification to the distorted signal according to control parameters that specify an amount of compensation to apply to the distorted signal. Such control parameters may be adaptive. In one embodiment, as illustrated, the adaptive equalizer control system 200 may include a linear equalizer (“LE”) 202, a 1-TAP decision feedback equalizer (“DFE”) 204, and an error detector 205. The adaptive control system 200 may also include an equalizer-control logic 208 for adjusting such control parameters. U.S. Pat. No. 7,760,798, entitled System and Method for Adjusting Compensation Applied to a Signal and issued 20 Jul. 2010, which is incorporated herein by reference, further describes adjusting control parameters to compensate for signal distortion. One or more of the equalizers in the adaptive equalizer control system 200 may apply compensation specified by the control parameter to compensate for distortion in the distorted signal. The present disclosure may refer to circuit components applying compensation for distortion in the distorted signal as being part of an adaptive equalizer or an adaptive equalizer control system. For example, in FIG. 2, an adaptive control system 200 includes the LE 202 and the 1-TAP DFE 204 to provide two-dimensional adaptive equalizer control.

In at least one embodiment, the adaptive equalizer control system 200 may use adaptive control based on one or more adaptive control algorithms, such as, for example, a Q-based Zero-Forcing (Q-ZF) algorithm that may not measure analog error value of residual ISI. In particular embodiments, LEs (in addition to DFEs) may utilize one or more adaptive control algorithms.

In at least one embodiment, the LE 202 may reduce ISI with greater than or equal to approximately 2.0 unit intervals (UIs) of delay. If the LE 202 applies too little compensation, the pulse response may include positive ISI greater than zero over multiple UIs of delay. For example, the pulse response may demonstrate positive ISI greater than zero over approximately 2.5, 3.0, and 3.5 UIs of delay. On the other hand, if an LE applies too much compensation, the pulse response may include negative ISI less than zero over multiple UIs of delay. The particular components chosen for an adaptive control system may depend on one or more characteristics of the transmission channel. For example, communication through particular transmission channels may benefit only slightly, if at all, from the use of an LE.

As illustrated, the DFE 204 is a 1-TAP DFE. The 1-TAP DFE may use a feedback loop from a decision circuit 203 to cancel ISI occurring after a delay of 1.0 UI. In particular embodiments, the LE and 1-TAP DFE may apply compensation that reduces and cancels residual ISI occurring after a particular number of UIs of delay.

As illustrated, the error detector 205 may generate an error value from the input and the output of the decision circuit 203 by subtracting a product of a target amplitude and the output of the decision circuit 203 from the input of the decision circuit 203. In at least one embodiment, the output of the error detector 205 may have a sign error value which indicates whether a sign of the error value is either positive or negative. In another embodiment, the output of the error detector 205 may have an analog error value which indicates a magnitude of the error value in addition to the sign of the error value.

As illustrated, an output of the 1-TAP DFE 204 (e.g., data) and an output of the error detector 205 (e.g., error) may be demultiplexed by DMUXs (demultiplexers) to match the clock frequency and may then be used by the equalizer-control logic 208. In these and other embodiments, the demultiplexed data may be used as the recovered data output.

The equalizer-control logic 208 may receive the demultiplexed data and error and may generate and transmit control parameters for controlling the amount of compensation that an equalizer may apply. In particular embodiments, equalizer-control logic 208 uses one or more filter pattern decoders to detect a residual ISI vector from the demultiplexed data and error and uses integrators to generate control parameters. As used herein, the phrase “residual ISI” may refer to one or more “residual ISI vectors” or one or more vector values of residual ISI vectors, except where a particular “residual ISI component” is specified. A residual ISI vector may be produced using any mathematical operations that produce vector output from any type of data, such as, for example, scalar data and vector data, and may have any length. Mathematical operations used to produce vector values may be performed any number of times and/or in a progressive manner to produce any number of vector values for any number of vectors. For example, an integrator may be updated one by one after a partial execution of a matrix multiplication for each row or for each element corresponding to the integrator. In particular embodiments, the equalizer-control logic 208 may use additional hardware such as an ADC (Analog-to-Digital Convertor) circuit to measure an analog error value. Alternatively, the equalizer-control logic 208 may adaptively control the control parameters using a scheme that does not use additional hardware, such as an ADC circuit. The equalizer-control logic 208 may adaptively control any suitable control parameter such as, for example, an LE parameter, a 1-TAP DFE coefficient, LE gain, and offset code, or any combination of suitable control parameters.

In at least some embodiments, the equalizer-control logic 208 may include and/or utilize an adaptation matrix, M. For example, the equalizer-control logic 208 may force weighted sum of residual ISI toward zero by detecting residual ISI and integrating each residual ISI component with a different weight according to the adaptation matrix, where weight depends on at least the equalizer type and the residual ISI. In some embodiments, the equalizer-control logic 208 may include a vector of binary values representing the sign (e.g., +, −) of residual ISI components. In some embodiments, the equalizer-control logic 208 may be compatible with any correlated data sequences, including monotone sequences (such as a repeated 0-1-0-1 pattern).

In at least one embodiment, the equalizer-control logic 208 may be implemented using techniques such as Zero-Forcing algorithms. With Zero-Forcing algorithms, the adaptation matrix may be calculated as a Jacobian (partial derivative) matrix of the impulse response (or the residual ISI vector) of a channel and equalizers combined together with respect to the vector of control parameters in the equilibrium state. It may reduce the sum of squares of the residual ISI in the equilibrium state. The Zero-Forcing algorithm may be Analog-based Zero-Forcing (A-ZF) algorithm, Sign-based Zero-Forcing (S-ZF) algorithm, or Q-based Zero-Forcing (Q-ZF) algorithm.

The adaptation matrix may be either statically fixed for the worst-case channel and the equalizers with the best values of the control parameters combined together, or dynamically varied for the channel and the equalizers under adaptation.

If the adaptation matrix is statically fixed for the worst-case channel and the equalizers with the best values of the control parameters combined together, it may minimize the sum of squares of the residual ISI in the equilibrium state for the worst-case channel. For other channels, the sum of squares of the residual ISI may not necessarily be minimized in the equilibrium state, but the sum of squares of the residual ISI may be often sufficiently reduced in the equilibrium state, because the operating margin may usually be bigger than the worst-case channel for a wide range of channel characteristics.

If the adaptation matrix is dynamically varied for the channel and the equalizers under adaptation, the sum of squares of the residual ISI may be minimized in the equilibrium state.

If the adaptation matrix is statically fixed for the worst-case channel and the equalizers with the best values of the control parameters combined together, the calculation of the adaptation matrix may be based on either simulation or measurement. If the calculation of the adaptation matrix is based on simulation, the calculated adaptation matrix may be validated or adjusted based on measurement.

If the adaptation matrix is dynamically varied for the channel and equalizers under adaptation, the calculation of the adaptation matrix must be based on measurement.

If the Zero-Forcing algorithm is the A-ZF algorithm, the residual ISI vector have an analog error value, the adaptation matrix may be based on the analog error value of the residual ISI vector. Hence, regardless of whether the adaptation matrix is statically fixed or dynamically varied, measurement of the analog error value of the residual ISI vector may be required to implement the A-ZF algorithm.

If the Zero-Forcing algorithm is the S-ZF algorithm, the residual ISI vector may have a sign error value, and the adaptation matrix may be based on the analog error value of the residual ISI vector. Hence, if the adaptation matrix is dynamically varied, measurement of the analog error value of the residual ISI vector may be used to implement the S-ZF algorithm. On the other hand, if the adaptation matrix is statically fixed, measurement of only sign error value of the residual ISI vector may be used to implement the S-ZF algorithm.

If the Zero-Forcing algorithm is the Q-ZF algorithm, the residual ISI vector may have only sign error value, and the adaptation matrix may be based on Q values of average sign error values of the residual ISI vector. Hence, regardless of whether the adaptation matrix is statically fixed or dynamically varied, measurement of sign error value of the residual ISI vector may be used to implement the Q-ZF algorithm.

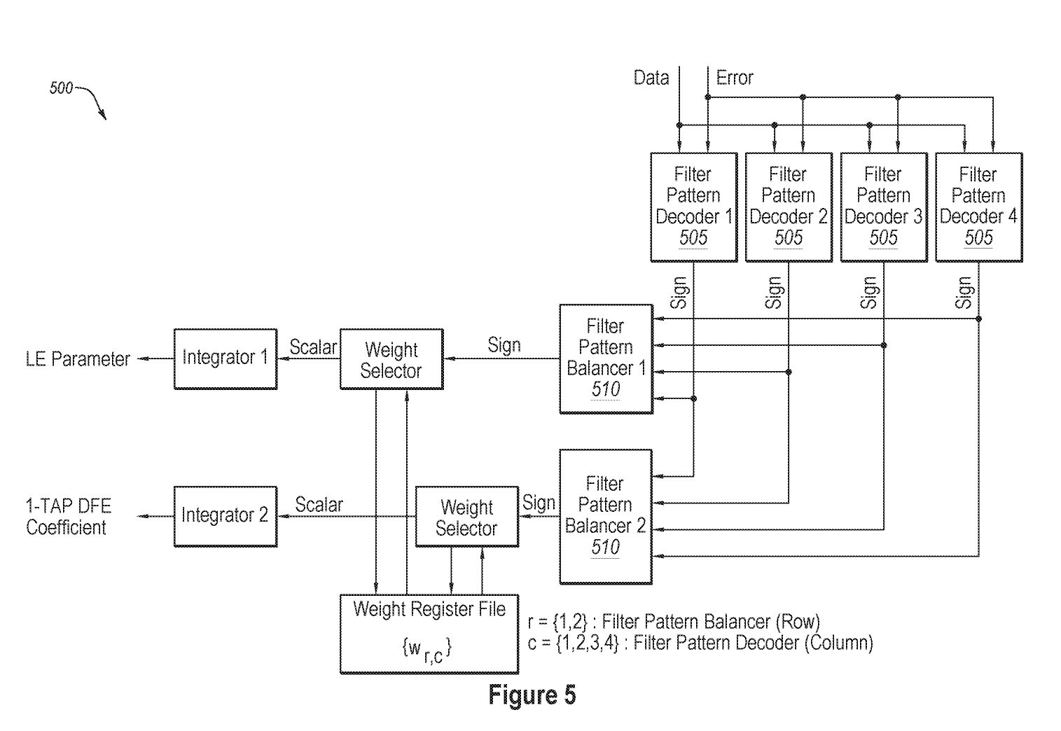

In at least one embodiment, the equalizer-control logic 208 may use the S-ZF or Q-ZF algorithm. In at least one embodiment, the S-ZF or Q-ZF algorithm may be configured to achieve statistically equivalent results to the results of the A-ZF algorithm in a long term. To implement the S-ZF or Q-ZF algorithm, the equalizer-control logic 208 may measure only sign error value, and may calculate the residual ISI vector that has only the sign error value. Then, the equalizer-control logic 208 may perform only simple arithmetic operations (i.e. only add or subtract operations without multiply operations) to generate control parameters, because the residual ISI vector has sign values without magnitude. The description below with respect to FIG. 5 further describes the equalizer-control logic 208 using the Sign-based or Q-based Zero-Forcing method for adaptive equalizer control.

Although the present disclosure may describe and illustrate particular equalizers including particular combinations of particular components for particular adaptive control using particular adaptive control algorithms, the present disclosure contemplates any suitable equalizer including any suitable combinations of any suitable components for any suitable adaptive control using any suitable adaptive control algorithms including any two-dimensional equalizer, any DFE, any LE, any CTLE, or any LFE. For example, particular embodiments may use adaptive control that is based on one or more adaptive control algorithms, such as, for example, a Least-Mean-Square (“LMS”) algorithm, a Sign-Sign-Least-Mean-Square (“SS-LMS”) algorithm, or a Q-based ZF algorithm.

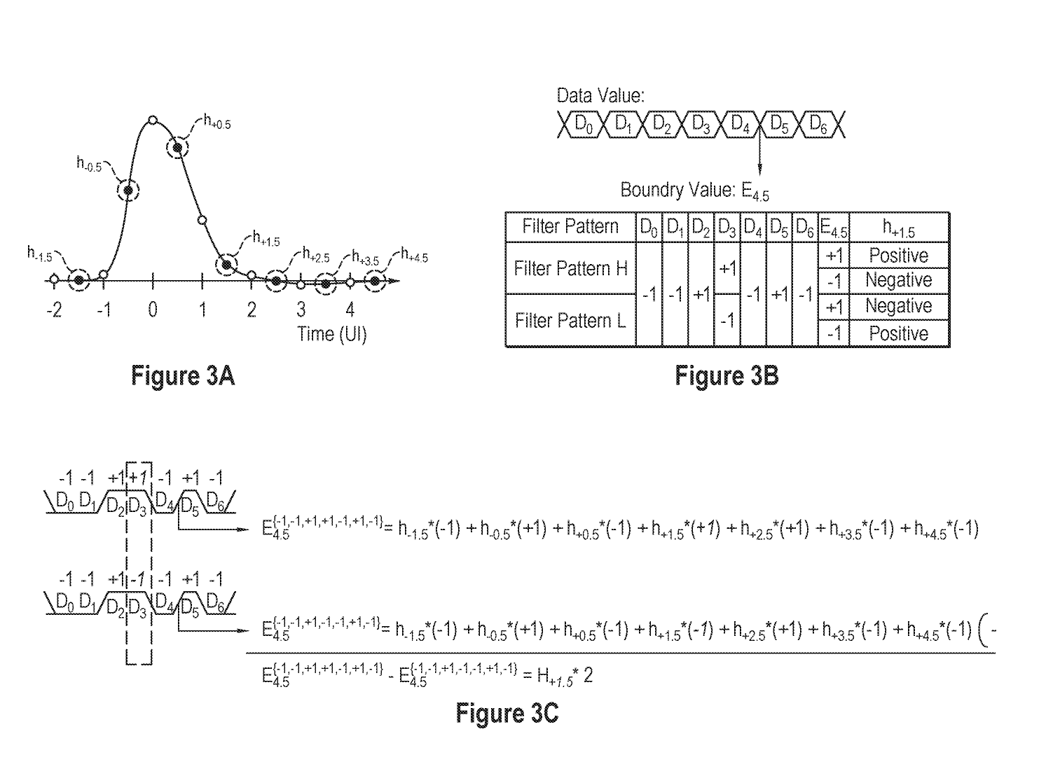

FIG. 3A illustrates an example pulse response of an example transmission channel. The transmission channel may communicate a signal from a transmitter to a receiver that includes an equalizer, which may process the received signal. The equalizer may communicate the processed signal in any suitable manner to a decision circuit or any other circuit components. After transmission over the transmission channel, the received signal of a pulse may have a long tail due to high-frequency loss in the transmission channel. The long tail may cause inter-symbol interference (“ISI”) because the long tail may interfere with successively transmitted symbols.

In some embodiments, there may be a symbol with two levels that may be transmitted, such as a symbol set of (0 and 1) or (−1 and +1). In such embodiments, the “0” or “−1” may represent logical zero or “false” values, while the “1” may represent logical one or “true” values. In other embodiments, a symbol with three levels may be used, such as a symbol set of (0, 1, and 2) or (−2, 0, and +2) or (0, ½, 1) or (−1, 0, 1). In yet other embodiments, a symbol with four levels may be used, such as a symbol set of (0, 1, 2, and 3) or (−3, −1, +1, and +3) or (0, ⅓, ⅔, and 1) or (−1, −⅓, +⅓, and +1). The present disclosure contemplates a symbol with any suitable number of levels. A signal using a symbol with two levels may be known as an NRZ signal. A signal using a symbol with four levels may be known as a PAM4 signal. The equalizer may cancel the ISI. The equalizer may use a feedback data from a decision circuit to cancel ISI occurring after a particular number of unit intervals (UI) of delay, such as a delay of 1.0 UI.

The receiver may include any suitable equalizer or combination of equalizers for receiving, at an input port, the signal from the transmitter and applying a gain, offset, or other modification to the signal according to control parameters that specify an amount of compensation to apply to the signal. Such control parameters may be adaptive, which may be desirable when one or more characteristics of the transmission channel are unknown.

In some embodiments, one or more of the equalizers in the receiver may use a control parameter. In these and other embodiments, the control parameter may specify an amount of compensation to apply to the signal from the transmitter to compensate for distortion in the signal. The control parameter may be adapted based on observation using one or more filter patterns. The present disclosure may refer to circuit components, which apply compensation for distortion in a signal, as being part of an adaptive equalizer or an adaptive equalizer control system. Reference to an adaptive equalizer may encompass an adaptive equalizer control system, and vice versa, where appropriate.

FIG. 3B illustrates two example filter patterns H and L for detecting ISI at 1.5 UIs of delay (h_{+1.5}). The filter patterns H and L may be composed of two data symbols +1 and −1 that are successively transmitted and received in an order as illustrated in FIG. 3B. Detection of ISI using two filter patterns may be performed according to techniques described in U.S. Pat. No. 8,503,519, entitled “Detecting residual ISI components using two data patterns” and issued 6 Aug. 2010, the entirety of which is incorporated by reference.

Filter patterns H and L may be sampled alternatively and, over a given time period, the two filter patterns H and L may be sampled approximately the same number of times. In some embodiments, the two filter patterns may behave in opposite manners regarding the polarity of error values. In some embodiments, a statistical difference of average of the error values between two filter patterns, which may be sampled approximately the same number of times, may correspond to an actual difference of the error values between the two filter patterns over a long term for any incoming data sequence, even if filter pattern H is received much more frequently than filter pattern L. Once the ISI is detected, systems described may adjust the control parameters of the equalizers to cancel the ISI.

FIG. 3C illustrates an example detection of ISI based on an error-value difference between two filter patterns H and L. In at least one embodiment, ISI may be measured by taking a difference in average of error values between two filter patterns that have different data values in the data bits corresponding to the ISI to be measured. In the illustrated example, h_{+1.5} may be measured by taking a difference in average of error values E_{4.5} between D₄ and D₅ for two filter patterns which have different data values at D₃. Data values D₀, D₀, D₂, D₄, D₅ and D₆ may be the same for both filter patterns. Each data value and error value may include a low value, a high value, any value, or a random value that takes either a high value or a low value randomly. In some embodiments, error value may include a quantity, which may be measured, for example, at a full-range precision analog error value. In some embodiments, error value may include sign error value. In at least one embodiment, a Q value may be used instead of the analog error value. The Q-value may represent a ratio of an analog error value to a standard deviation of a noise, and may be calculated using an average of the sign error value E[sgn(x)] using an inverse error function, erfinv(E[sgn(x)]).

In at least one embodiment, ISI may, to some degree, be measured for its sign and for its magnitude by taking statistical differences of average of the binary error values for the two filter patterns. For example, the probabilities of +1 (or −1) error values may be the same for the two filter patterns in FIG. 3C, if the ISI h_{+1.5} is absolutely zero. Otherwise, the probability of +1 error values may be higher (or lower) for the filter pattern with D₃ equal to +1 than the filter pattern with D₃ equal to −1, depending on whether the ISI at 1.5 UIs of delay (h_{+1.5}) is positive (or negative). The amount of statistical difference of average of the binary error values for the two filter patterns may indicate the magnitude of the ISI at 1.5 UIs of delay (h_{+1.5}). For example, when the ISI at 1.5 UIs of delay (h_{+1.5}) becomes positive with higher (or lower) magnitude, the probability of +1 error values for the filter pattern with D₃ equal to +1 subtracted with the probability of +1 error values for the filter pattern with D₃ equal to −1 becomes positive with higher (or lower) magnitude.

If the binary error values are statistically saturated, the difference in binary error values between the two filter patterns is zero and may not be used to measure ISI. To prevent statistical saturation of the binary error values between the two filter patterns, a magnitude of aggregate ISI of the common part of the two filter patterns may be reduced. To reduce the magnitude of aggregate ISI of the common part of the two filter patterns, the data values of the common part of the two filter patterns may be approximately balanced. For example, the number of high values present in the common part of the two filter patterns (e.g., the data values that may be the common part of the two filter patterns, D₀, D₀, D₂, D₄, D₅ and D₆ in FIG. 3C) used to calculate the difference in binary error values between the two filter patterns may be close to (and thus balanced with) the number of low values present in the common part of the two filter patterns (e.g., D₀, D₀, D₂, D₄, D₅ and D₆ in FIG. 3C) used to calculate the difference in binary error values between the two filter patterns.

The aggregate ISI of the common part of the two filter patterns or two extended filter patterns (e.g., D₀, D₀, D₂, D₄, D₅ and D₆ in FIG. 3C) may be referred to as “μ.” In at least one embodiment, μ may be represented as h_{-1.5}*(−1)+h_{-0.5}*(+1)+h_{+0.5}*(−1)+h_{+2.5}*(+1)+h_{+3.5}*(−1)+h_{+4.5}*(−1). Filter patterns and extended filter patterns may be most effective when the magnitude of the aggregate ISI of the common part of the filter patterns (“μ”) is reduced. The optimization of two filter patterns and/or two extended filter patterns by reducing the magnitude of μ may be performed according to techniques described in U.S. patent application Ser. No. 14/968,621, entitled “Sign-based Adaptive Control with Automatically-Selected Filter Patterns” and filed on Dec. 14, 2015, the entirety of which is incorporated by reference.

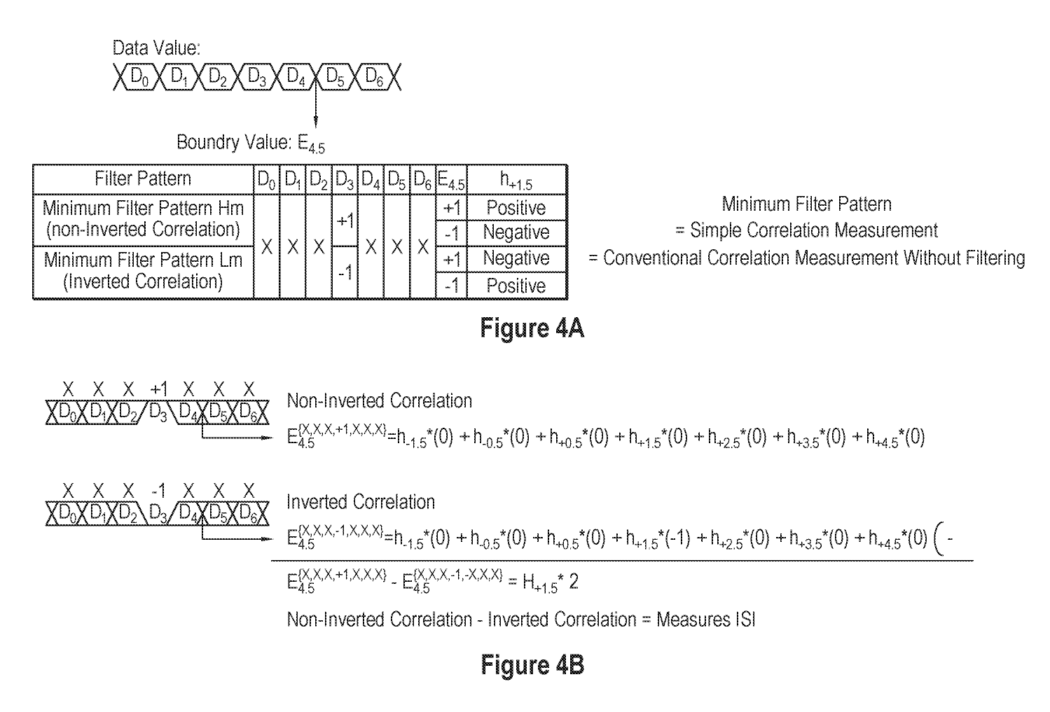

FIG. 4A illustrates two example minimum filter patterns Hₘ and Lₘ for detecting ISI at 1.5 UIs of delay (h_{+1.5}). The minimum filter pattern Hₘ may include a non-inverted correlation and the minimum filter pattern Lₘ may include an inverted correlation. The minimum filter patterns Hₘ and Lₘ may be composed of a data symbol with two levels +1 and −1 that is transmitted at a particular data value as illustrated in FIG. 4A. Minimum filter patterns may be used for lightweight or simple correlation measurement. In at least one embodiment, little or no filtering may occur when using a minimum filter pattern.

Minimum filter patterns Hₘ and Lₘ may be sampled alternatively and, over a given time period, the two minimum filter patterns Hₘ and Lₘ may be sampled approximately the same number of times. In some embodiments, the two minimum filter patterns may behave in opposite manners regarding the polarity of error values. In some embodiments, a statistical difference of average of the error values between two minimum filter patterns, which may be sampled approximately the same number of times, may correspond to an actual difference of the error values between the two minimum filter patterns over a long term for any incoming data sequence, even if filter pattern Hₘ is received much more frequently than filter pattern Lₘ. Once the ISI is detected, systems described may adjust the control parameters of the equalizers to cancel the ISI.

FIG. 4B illustrates an example detection of ISI based on an error-value difference between two minimum filter patterns Hₘ and Lₘ. In at least one embodiment, ISI may be measured by taking a difference in average of error values between two minimum filter patterns that have different data values in the data bits corresponding to the ISI to be measured. In the illustrated example, h_{+1.5} may be measured by taking a difference in average of error values E_{4.5} between D₄ and D₅ for two minimum filter patterns which have different data values at D₃. Data values D₀, D₀, D₂, D₄, D₅ and D₆ may be any value (i.e. indicated by ‘X’ which represents either high or low value and has expected value of zero) for both filter patterns. Each data value and error value may include a low value, a high value, any value, or a random value that takes either a high value or a low value randomly.

In at least one embodiment, ISI may, to some degree, be measured for its sign and for its magnitude by taking statistical differences of average of the binary error values for the two minimum filter patterns. For example, the probabilities of +1 (or −1) error values may be the same for the two minimum filter patterns in FIG. 4B, if the ISI h_{+1.5} is absolutely zero. Otherwise, the probability of +1 error values may be higher (or lower) for the filter pattern with D₃ equal to +1 than the filter pattern with D₃ equal to −1, depending on whether the ISI at 1.5 UIs of delay (h_{+1.5}) is positive (or negative). The amount of statistical difference of average of the binary error values for the two minimum filter patterns may indicate the magnitude of the ISI at 1.5 UIs of delay (h_{+1.5}). For example, when the ISI at 1.5 UIs of delay (h_{+1.5}) becomes positive with higher (or lower) magnitude, the probability of +1 error values for the minimum filter pattern with D₃ equal to +1 subtracted with the probability of +1 error values for the minimum filter pattern with D₃ equal to −1 becomes positive with higher (or lower) magnitude.

The aggregate ISI of the common part of the two minimum filter patterns (e.g., D₀, D₁, D₂, D₄, D₅ and D₆ in FIG. 4B) may be referred to as “μₘ” Each value in the common part of the two minimum filter patterns may be any value, either positive or negative, and hence its average effect is none. In at least one embodiment, μₘ may be represented as h_{-1.5}*(0)+h_{-0.5}*(0)+h_{0.5}*(0)+h_{2.5}*(0)+h_{3.5}*(0)+h_{4.5}*(0). By not considering the common part of the two minimum filter patterns, the measured ISI may be equal to a difference between the non-inverted correlation and the inverted correlation.

FIG. 5 illustrates an example equalizer-control logic 500 using an example Sign-based or Q-based ZF method. In at least one embodiment, the Sign-based or Q-based ZF method of FIG. 5 may be configured to achieve statistically equivalent results to the results of the Analog-based Zero-Forcing algorithm in a long term. The Sign-based or Q-based method may use sign error values of residual ISI in a binary form and may perform add and subtract operations instead of multiply operations.

One or more filter pattern decoders 505 (e.g., filter pattern decoders 1 through 4) may detect sign of residual ISI using the Sign-based or Q-based ZF method. The filter pattern decoders 1 through 4 may switch between multiple sets of filter patterns. Each filter pattern decoder 505 may be programmed to detect sign of residual ISI using any filter patterns, data sequences or sets of filter patterns or data sequences in any format. For example, a first filter pattern decoder 1 may be programmed to detect sign of the ISI at 1.5 UIs of delay (h_{+1.5}) by implementing the filter pattern H and the filter pattern L as shown in FIG. 3B and taking statistical differences of average of the sign error value between the filter pattern H and the filter pattern L as illustrated in FIG. 3C. A second filter pattern decoder 2 may be programmed to detect sign of the ISI at 2.5 UIs of delay (h_{+2.5}) by implementing two filter patterns H₂ and L₂ between which the values of D₂ in the truth table shown in FIG. 3B may be differentiated, and the values of D₃ may be the same. Each filter pattern decoder 505 may use and switch between any interface modes and applications of adaptive control actions and operate during and switch between any periods of operation, such as during initialization, after initialization, and in use, because there may be different requirements such as available data sequences for adaptation and desired (or required) level of optimization.

The Sign-based or Q-based Zero-Forcing method may be more efficient and may use less hardware than adaptive control using conventional Analog-based Zero-Forcing algorithm that measures quantity (e.g., analog error value) of residual ISI by an Analog-to-Digital Converter (ADC) and perform multiplication operations between a matrix and a vector. In at least one embodiment, the Sign-based or Q-based Zero-Forcing method does not use an ADC.

If the adaptation matrix is dynamically varied for the channel and equalizers under adaptation, the Q-based Zero-Forcing method may be more efficient and may use less hardware than adaptive control using the Sign-based Zero-Forcing method or conventional Analog-based Zero-Forcing algorithm that measure quantity (e.g., analog error value) of residual ISI by an Analog-to-Digital Converter (ADC) and perform calculation of the adaptation matrix. In at least one embodiment, the Q-based Zero-Forcing method does not use an ADC.

In at least one embodiment, a micro-controller may be used to calculate inverse error functions and/or to calculate matrix inverses for use in the Q-based method. The Sign-based or Q-based method may add or subtract weight to the control parameter depending on the sign error values of residual ISI. In at least one embodiment, the Sign-based or Q-based method may balance the number of operations between residual ISI components (and optionally between control parameters). In at least one embodiment, the Sign-based or A-based method may be implemented for any equalizer, including any two-dimensional equalizer, any DFE and any LE, such as a CTLE with any control parameter.

The equalizer-control logic 500 may include one or more filter pattern balancers 510. A filter pattern balancer 510 may select one filter pattern decoder 505 at a time, and may process two results (e.g., one for a filter pattern H and another for filter pattern L in FIG. 3B) in a row from the selected filter pattern decoder 505. After the filter pattern balancer 510 processes two results in a row from the selected filter pattern decoder 505, the filter pattern balancer 510 selects a next filter pattern decoder 505 in sequence or at random. In particular embodiments, in a long term, the filter pattern balancer 510 may take into account results from each filter pattern decoder 505 for the same number of times. This may be performed for any incoming data sequence, even if matching of the incoming data sequence with one filter pattern decoder 505 may occur quite often, whereas matching of the incoming data sequence with another filter pattern decoder 505 may be rare.

When a filter pattern decoder 505 selected by the filter pattern balancer 510 detects incoming data sequence matching with the filter pattern that the filter pattern decoder 505 is looking for, the weight selector may read out a weight value from a two dimensional weight register file indexed by the filter pattern balancer 510 (row) and the filter pattern decoder 505 (column). Then, according to the sign of the residual ISI which is indicated by the sign of the error value received together with the filter pattern and by the polarity of the filter pattern whether non-inverted or inverted, the weight value is added to or subtracted from the value of the control parameter, which is for example either the LE parameter or the 1-TAP DFE coefficient. The weight register file may be programmed to include information equivalent to the adaptation matrix.

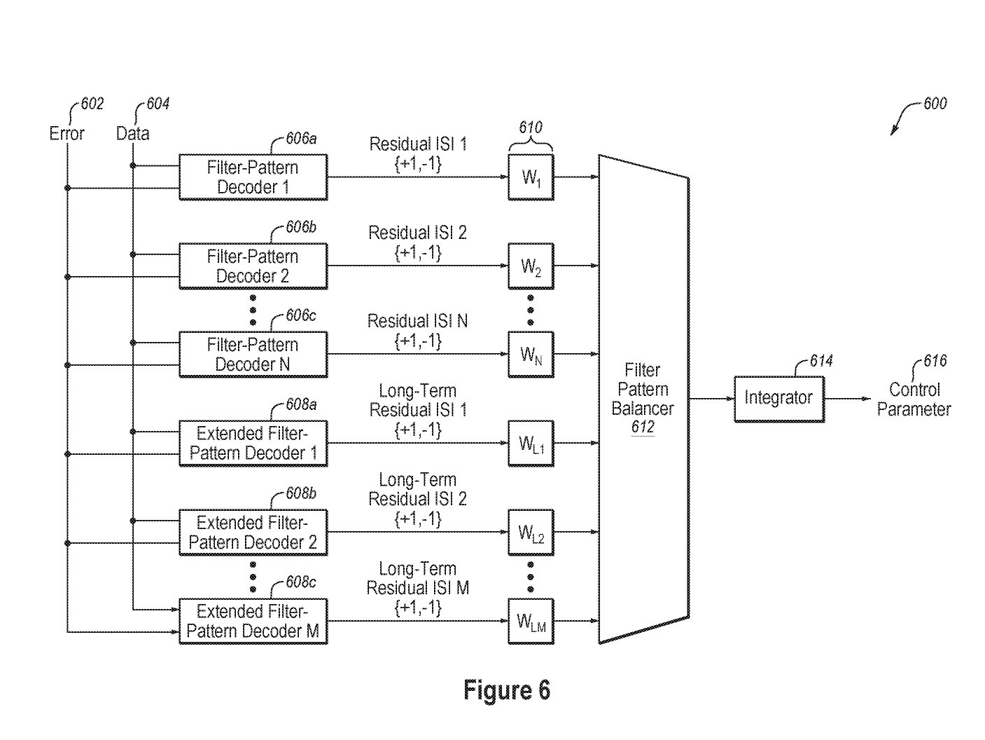

FIG. 6 illustrates a block diagram of an example embodiment of an adaptive equalizer controller 600 using an extended Sign-based or Q-based Zero-Forcing method. In one embodiment, the adaptive equalizer controller 600 may be configured to use extended Sign-based or Q-based zero-forcing. The adaptive equalizer controller 600 may be implemented in part by one or more portions of the equalizer-control logic of FIG. 5. In one embodiment, the adaptive equalizer controller 600 may include enhancements or additions to the equalizer-control logic of FIG. 5. The adaptive equalizer controller 600 may implement, for example, the adaptive equalizer controller 108 of FIG. 1, or any other adaptive equalizer controller.

The adaptive equalizer controller 600 may include inputs for error 602 and for data 604. In some embodiments, the error 602 and the data 604 may be received from, for example, the data and error detector 106 of FIG. 1.

In at least one embodiment, the adaptive equalizer controller 600 may include one or more filter-pattern decoders 606 configured to detect sign of short-term residual ISI. The adaptive equalizer controller 600 may include as many filter-pattern decoders 606 as necessary or desirable to adequately detect short-term residual ISI. Each of the filter-pattern decoders 606 may be implemented, for example, by the filter pattern decoder 505 of FIG. 5. Each of the filter-pattern decoders 606 may output sign values of short-term residual ISI.

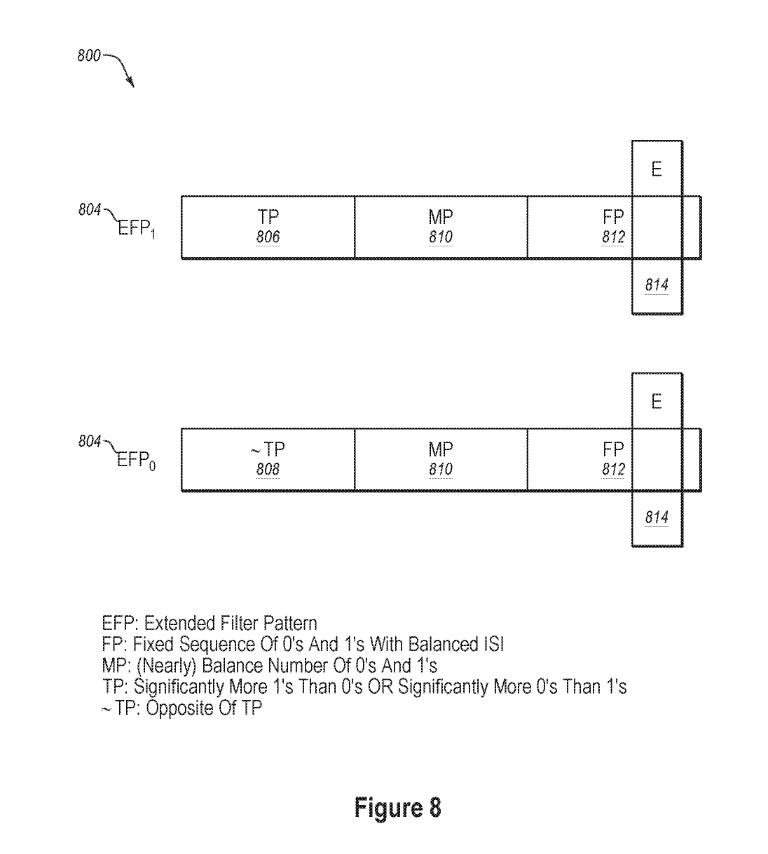

The adaptive equalizer controller 600 may include one or more extended filter-pattern decoders 608. The adaptive equalizer controller 600 may include as many extended filter-pattern decoders 608 as necessary or desirable to adequately address long-term residual ISI. Each of the extended filter-pattern decoders 608 may be configured to detect long-term residual ISI. In one embodiment, each of the extended filter-pattern decoders 608 may be configured to detect sign of long-term residual ISI. Each of the extended filter-pattern decoders 608 may be configured to detect long-term residual ISI using extended filter patterns for any suitable data patterns, data sequences or sets of data patterns or data sequences in any format. Example extended filter patterns are discussed in more detail within the context of FIG. 8 below. Each of the extended filter-pattern decoders 608 may utilize and switch between any interface modes and applications of adaptive control actions and operate during and switch between any periods of operation, such as during initialization, after initialization, and in use.

Each of the extended filter-pattern decoders 608 may be configured to output a sign value corresponding to the long-term residual ISI indicating whether its input indicates that the associated equalizer needs to increase or decrease its compensation of the signal for long-term ISI. In one embodiment, each of the extended filter-pattern decoders 608 may be configured to output: a “+1” if its input indicates that the associated equalizer is to increase its compensation; and a “−1” if its input indicates that the associated equalizer needs to decrease its compensation.

The adaptive equalizer controller 600 may include one or more weights 610 to apply to the output of filter pattern decoders 606 and/or extended filter-pattern decoders 608. Weights 610 may be configured to hold a portion to add to or subtract from the output control parameter 616. Use of weights 610 may be configured to weigh the effect of operations between residual ISI components and, optionally, between control parameters. In one embodiment, weights 610 may be implemented fully or in part by the weight selectors and weight register file of FIG. 5. The selection of weights 610 may be made based on the type of equalizer for which control parameters are generated.

The adaptive equalizer controller 600 may include a filter pattern balancer 612 configured to further balance the effect of operations between filter-pattern decoders 606 and extended filter-pattern decoders 608 of adaptive equalizer controller 600. Filter pattern balancer 612 may thus enable adaptive control algorithms to provide consistent adaptation results among various data sequences. Filter pattern balancer 612 may be implemented in any suitable manner, including wholly or in part by a filter pattern balancer 510 of FIG. 5. The adaptive equalizer controller 600 may include an integrator 614 configured to integrate the results of filter pattern balancer 612. The integrator 614 may be configured to compile, normalize, limit, or otherwise condition the results of filter pattern balancer 612 to generate a control parameter 616 that is acceptable for use with an equalizer.

In one embodiment, the adaptive equalizer controller 600 may be implemented using only extended filter-pattern decoders 608. In such an embodiment, the adaptive equalizer controller 600 may be specifically configured to adaptively control an equalizer for long-term residual ISI such as a low-frequency continuous-time linear equalizer. In another embodiment, filter pattern balancer 612 and weights 610 may be configured to adequately balance response for short-term residual ISI and long-term residual ISI. Thus, in such an embodiment, the adaptive equalizer controller 600 may be configured to adaptively control an equalizer for both short-term and long-term residual ISI.

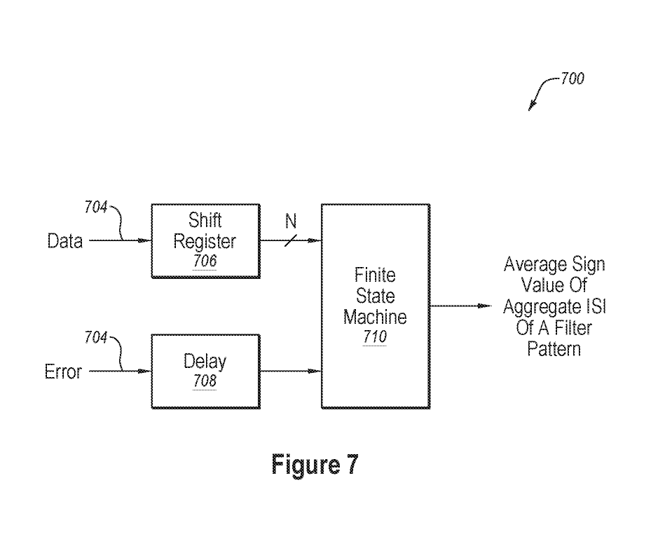

FIG. 7 illustrates a block diagram of an example embodiment of a filter-pattern decoder 700. In one embodiment, the filter-pattern decoder 700 may implement one or more of the filter pattern decoders 505 of FIG. 5, one or more of the filter pattern decoders 606 or one or more of the extended filter-pattern decoders 608 of FIG. 6. Data 702 and error 704 may be received by filter-pattern decoder 700. In some embodiments, the data 702 and the error 704 may be received from, for example, the data and error detector 106 of FIG. 1. A delay block 708 may delay the error 704 to compensate for various actions performed upon data 702. The filter-pattern decoder 700 may include a shift register 706 configured to separate the data 702 into discretized portions which may be compared, matched, and evaluated by a finite state machine 710.

The finite state machine 710 may be configured to match the data 702 with a filter pattern or with an extended filter pattern to detect residual ISI or long-term residual ISI and, once such matches are made, further use the corresponding error 704 to determine an appropriate sign of residual ISI or long-term residual ISI. The finite state machine 710 may be implemented in any suitable manner, such as by any suitable combination of analog or digital circuitry. In one example, the finite state machine 710 may be implemented by instructions on a computer readable medium for execution by a processor. The finite state machine 710 may include one or more pairs of filter patterns or extended filter patterns for which the finite state machine 710 is searching for matches within the data 702. Such matches may provide the comparisons necessary to perform determinations of a sign of residual ISI or long-term residual ISI. The configuration of the finite state machine 710 may be represented by one or more truth tables.

FIG. 8 illustrates example embodiments of a pair of extended filter-patterns 802, 804 configured to detect long-term ISI. The extended filter-patterns (“EFP”) 802, 804 may be used by the adaptive control system 100 of FIG. 1 to evaluate the distorted signal. The extended filter-patterns 802, 804 may each include one or more logical sections, representing a portion of received data that is to be matched. Detection of long-term ISI using two extended filter patterns may be performed according to techniques described in U.S. Pat. No. 9,020,082, entitled “Adaptive Control of Low-Frequency Equalizers” and issued on Apr. 28, 2015, the entirety of which is incorporated by reference.

Each of the EFPs 802, 804 may include patterns corresponding to different portions of a data sequence. Such portions may include, for example, a filter pattern, a middle pattern, and a tail pattern. A filter pattern (“FP”) may include a set of values before and after an error value. An error value, “E”, may provide the detection of residual long-term ISI. An FP may be preceded by a middle pattern (“MP”) and a tail pattern (“TP”). A TP may be referenced by an observed condition, where ISI from TP on the detected error E may be caused by a long tail of a pulse response with long-term ISI.

In one embodiment, a set of matching EFPs may differ by the respective TP of each EFP. Thus, in the example of FIG. 8, the EFP₁ 802 and EFP₀ 804 may each include the same FP 812 before and after the error value E 814, and include the same MP 810. However, the EFP₁ 802 and EFP₀ 804 may include different TPs. Specifically, the EFP₀ 804 may include a ˜TP 808 that is the complement of a TP 806 which may be included in the EFP₁ 802. By subtracting the E 814 in the EFP₀ 804 from the E 814 in the EFP₁ 802, the effects from the FP 812 and the MP 810 on error the E 814 are cancelled so that long-term ISI is detected as the non-inverted effect from the TP 806 and the inverted (e.g., complement) effect from the ˜TP 808 on error the E 814.

In one embodiment, the EFP₁ 802 and the EFP₀ 804 may each include a middle pattern such as the MP 810. In another embodiment, the EFP₁ 802 and the EFP₀ 804 may not include a middle pattern. The MP 810 may match with any data sequence which has a balanced number of data bits with differing values. For example, for data sequences with “0”s and “1”s, the MP 810 may match with exactly or approximately the same number of “0”s and “1”s so that aggregate ISI from the MP 810 is negligible. It may be assumed that ISI from most bits of the MP 810 are similar to each other, having a similar order of magnitude and the same sign. Therefore, if the data sequence matched with the MP 810 has exactly the same number of “0”s and “1”s then the aggregate ISI may be assumed to be negligible. Further, the MP 810 may be configured to accept matching with an approximately equal number of “0”s and “1”s. The more differences between the number of “0”s and “1”s allowed by the MP 810, the less accurate the determination of ISI that may be made by the EFP₁ 802 and the EFP₀ 804. In one embodiment, the MP 810 may be configured to accept matching with an equal number of “0”s and “1”s with an error range of plus or minus five percent. In another embodiment, the “0”s and “1”s matched with the MP 810 may be unordered. Consequently, the probability of the MP 810 matching with a random data sequence may be high even with long sequences of the MP 810. The efficiency of the EFP₁ 802 and the EFP₀ 804 may thus be increased by allowing a slightly unequal number of “0”s and “1”s or unordered “0”s and “1”s which may increase the probability of the MP 810 matching a random data sequence. This increase of efficiency may be made at the expense of degraded accuracy due to the difference between the number of “0”s and “1”s. However, by applying the same restrictions upon the MP 810 in each of the EFP₁ 802 and the EFP₀ 804, the expected effect on ISI by the data sequence matched with the MP 810 may be similar between the EFP₁ 802 and the EFP₀ 804.

The tail patterns of the EFP₁ 802 or the EFP₀ 804 may match with any data sequence which has significantly more “0”s than “1”s or significantly more “1”s than “0”s. Either such condition may cause the aggregate ISI from the data sequence matched with the tail pattern the TP 806 or the ˜TP 808 to the error E 814 to have significant magnitude. The requirements for the relationship between the numbers of “0”s and “1”s may be swapped between the EFP₁ 802 and the EFP₀ 804 so that the aggregate ISI may have the opposite sign between the EFP₁ 802 and the EFP₀ 804. Consequently, while the EFP₁ 802 may include the TP 806, the EFP₀ 804 may include the ˜TP 808 that may be a complement of the TP 806. If the TP 806 includes significantly more “0”s than “1”s, then the ˜TP 808 may likely include significantly more “1”s than “0”s. Conversely, if the TP 806 includes significantly more “1”s than “0”s, then the ˜TP 808 may likely include significantly more “0”s than “1”s. Further, if the ˜TP 808 includes significantly more “0”s than “1”s, then the TP 806 may likely include significantly more “1”s than “0”s. Conversely, if the ˜TP 808 includes significantly more “1”s than “0”s, then the TP 806 may likely include significantly more “0”s than “1”s. The order of “0”s and “1”s in the TP 806 and the ˜TP 808 may be unrestricted. Consequently, the probability of the TP 806 and the ˜TP 808 matching a random data sequence is high enough to be practical for use of the EFP₁ 802 or the EFP₀ 804, even when the length of the TP 806 and the ˜TP 808 is long such as more than 100 bits.

The magnitude of the aggregate ISI may increase as the disparity between the number of “0”s and “1”s in the TP 806 and the ˜TP 808 grows. Further, the accuracy of measuring the aggregate ISI may increase as the greater disparity between the number of “0”s and “1”s in the TP 806 and the ˜TP 808 grows. However, the greater disparity that is required to match the TP 806 and the ˜TP 808 between the number of “0”s and “1”s, the probability of the TP 806 and the ˜TP 808 matching in a random data sequence decreases. Therefore, the TP 806 and the ˜TP 808 may include a trade-off between accuracy and speed of ISI measurement. The selection of a given threshold for the relative number of “0”s and “1”s in the TP 806 and the ˜TP 808 may be made balancing these considerations. In one embodiment, the TP 806 and the ˜TP 808 may specify a 10, 15, 20, 22, 25, 28, or 30 percent difference in the number of “0”s and “1”s.

The MP 810 may be configured to cancel the effect of non-long-term ISI and to separate the TP 806 and the ˜TP 808 from the E 814 sufficiently such that only long-term ISI is detected, while keeping the probability of detecting the pattern in a random data sequence high enough to be practical. In at least one embodiment, the MP 810 may be omitted if the TP 806 and the ˜TP 808 directly precede the FP 812.

The FP 812 may be configured to accurately cancel the effect of short-term ISI, which may be significant relative to long-term ISI. In at least one embodiment, the FP 812 may be omitted if the location of the E 814 is located near the end of the MP 810. In at least one embodiment, both the FP 812 and the MP 810 may be omitted by causing detection of the E 814 near the end of the TP 806 and the ˜TP 808.

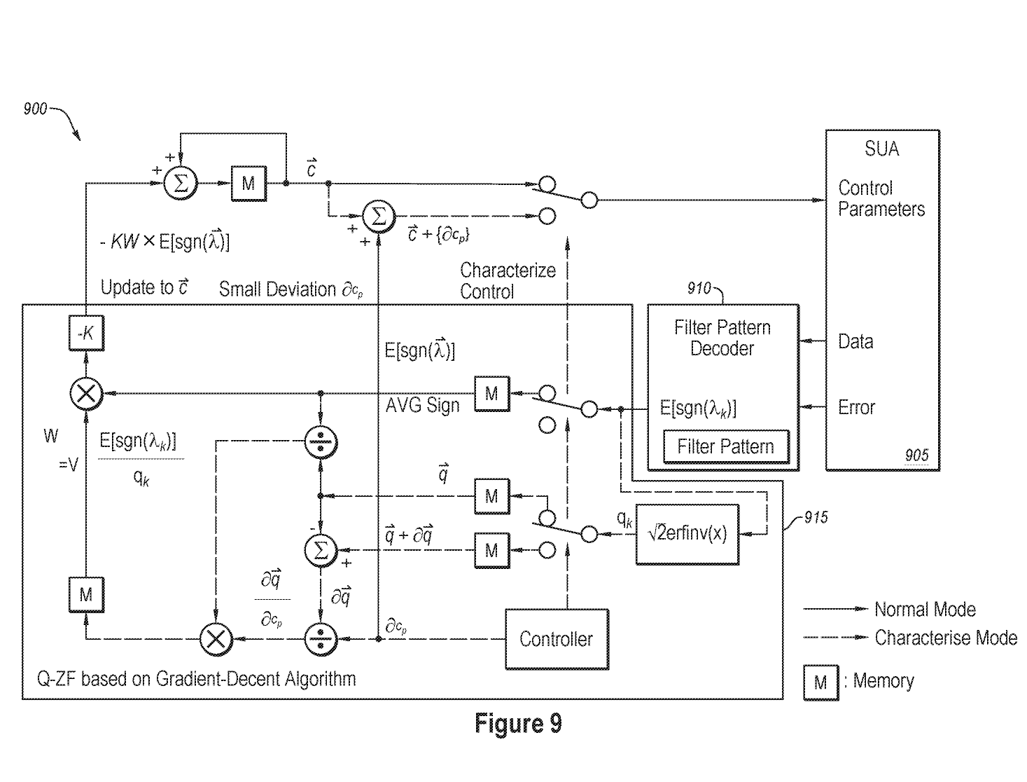

FIG. 9 illustrates a block diagram of an example adaptive control system 900 that may use a Gradient-Descent algorithm with Q-ZF adaptive control. The Gradient-Descent algorithm is an optimization algorithm that optimizes control parameters c by iteratively updating the control parameters c in a direction in which a sum of squared errors decreases with the steepest descent.

The adaptive control system 900 may include a system under adaptation (SUA) 905. The adaptive control system 900 may provide control parameters (e.g., a vector represented as \vec{c}) to the SUA 905. The SUA 905 may output data and error.

The adaptive control system 900 may iteratively generate the control parameters \vec{c} by integrating updates to \vec{c} from an adaptation algorithm. The adaptive control system may run in two modes: normal mode and characterize mode. The solid arrows of the adaptive control system 900 may indicate various operations that may occur in both of the normal mode and the characterize mode. In the normal mode, the control parameters [symbol] are given to the SUA 905 without small deviation ∂cₚ. The dashed lines of the adaptive control system 900 may indicate various operations that may occur only in the characterize mode in which the small deviation ∂cₚ may be injected to the control parameters [symbol] for each p one by one, and corresponding deviation of error vector ∂ [symbol] is observed.

When in the characterize mode, the adaptive control system 900 may inject a small deviation (∂cₚ) to control parameters [symbol] . The adaptive control system 900 may use the adaptation algorithm to monitor any change in the output of the SUA 905 (e.g., changes in the error vector) as a result of the small deviation (∂cₚ) injected to control parameters [symbol] . The adaptive control system 900 may identify differences in the output of the SUA 905 for different control parameters [symbol] and may use those differences to characterize the SUA 905. For Q-ZF systems, Filter Pattern Decoder 910 may detect residual ISI sign value based on the data and the error from the SUA 905. The residual ISI sign value may be measured by one or more filter patterns. The residual ISI sign value is input to an adaptation algorithm 915, which may be used to adjust the control parameters [symbol] . The control parameters [symbol] may be used to equalize distorted signals in the SUA 905. In the normal mode when the SUA 905 is not being characterized, the small deviation (∂cₚ) is not injected to the control parameters [symbol] .

The Filter Pattern Decoder 910 may use filter patterns to generate the residual ISI sign value. According to the Central Limit Theorem, when a filter pattern covers a large number of ISIs, the sum of remaining minor ISIs may follow the Gaussian Distribution. Thus, an expected value (or average) of sign values of residual ISI E[sgn(λₖ)] may be approximated as follows:

E[sgn(λₖ)]≈erf(λₖ/\sqrt{2σ²}),

where, λₖ is an analog value of the residual ISI, sgn(x) is a sign function, E[x] is an expected value (or average) of x, σ is the standard deviation of measurement noise due to minor ISIs not covered by the filter pattern or external noise such as cross talk or thermal noise, and erf(x) is the error function of x as defined as

$$erf ( x ) = \frac{2}{\sqrt{π}} {\int }_{0}^{x} exp ( - {t}^{2} ) dt .$$

By applying the inverse error function erfinv(•) to both sides of the above equation, the result may be expressed as:

erfinv(E[sgn(λₖ)])≈erfinv(erf(λₖ/\sqrt{2σ²}))=λₖ/\sqrt{2σ²},

where, erfinv(x) is the inverse error function of x that is defined for −1≦x≦+1 as erf(erfinv(x))=x, which may be rewritten using y=erfinv(x) as erfinv(erf(y))=y for −∞≦y≦+∞. Therefore, the Q value of ISI may be represented as: qₖ=λₖ/σ, which may be a ratio of residual ISI λₖ to measurement noise a and is approximately estimated by taking the inverse error function of the expected value (or average) of sign values of residual ISI E[sgn(λₖ)] as follows:

qₖ=λₖ/σ≈\sqrt{2}erfinv(E[sgn(λₖ)]).

The adaptation algorithm 915 may use this equation when determining Q values. If the measurement noise σ is constant, the Q value of ISI qₖ may be proportional to the analog value of residual ISI λₖ. In at least one embodiment, the output of Filter Pattern Decoder (E[sgn(λₖ)]) may switch alternatively between E[sgn(λ_{FP1}_{ₖ})] for a first (or non-inverted) filter pattern FP1ₖ and −E[sgn(λ_{FP0}_{ₖ})] for a second (or inverted) filter pattern FP0ₖ. For Q-ZF, the output of qₖ=2erfinv(x)=\sqrt{2}erfinv(E[sgn(λₖ)]) may be the difference between E[sgn(λ_{FP1}_{ₖ})] for the first (or non-inverted) filter pattern FP1ₖ and E[sgn(λ_{FP0}_{ₖ})] for the second (or inverted) filter pattern FP0ₖ as qₖ=\sqrt{2}erfinv(E[sgn(λ_{FP1}_{ₖ}])−\sqrt{2}erfinv(E[sgn(λ_{FP0}_{ₖ})]).

In at least one embodiment, the adaptation algorithm 915 together with the Filter Pattern Decoder 910 may use at least two filter patterns to determine a Q value. The expected value (or average) of sign values of residual ISI may be written approximately as follows:

E[sgn(λ_{FP1}_{ₖ})]≈erf(λ_{FP1}_{ₖ}/\sqrt{2σ²}) and,

E[sgn(λ_{FP0}_{ₖ})]≈erf(λ_{FP0}_{ₖ}/\sqrt{2σ²}),

where λ_{FP1}_{ₖ} and λ_{FP0}_{ₖ} are analog values of aggregate ISI measured by a first (or non-inverted) filter pattern FP1ₖ and a second (or inverted) filter pattern FP0ₖ, respectively, where FP1ₖ and FP0ₖ are similar but differentiated for residual ISI to be measured λₖ. By applying the inverse error function to both sides of the above equations, the result may be represented as:

erfinv(E[sgn(λ_{FP1}_{ₖ})])≈erfinv(erf(λ_{FP1}_{ₖ}/\sqrt{2σ²}))=π_{FP1}_{ₖ}/\sqrt{2σ²}, and

erfinv(E[sgn(λ_{FP0}_{ₖ})])≈erfinv(erf(λ_{FP0}_{ₖ}/\sqrt{2σ²}))=π_{FP0}_{ₖ}/\sqrt{2σ²},

where, the residual ISI to be measured λₖ may be the difference between the analog values of aggregate ISI for the first (or non-inverted) filter pattern λ_{FP1}_{ₖ} and the analog values of aggregate ISI for the second (or inverted) filter pattern λ_{FP0}_{ₖ} as follows:

λₖ=Δ_{FP1}_{ₖ}−λ_{FP0}_{ₖ}.

Thus, the Q value of residual ISI, qₖ=λₖ/σ, may be estimated by taking the difference of inverse error function of the expected value (or average) of sign values of residual ISI between FP1ₖ and FP0ₖ which may be represented as follows:

$$\begin{matrix}{q}_{k} = {λ}_{k} / σ \\ = {λ}_{FP 1} / σ - {λ}_{FP {0}_{k}} / σ \\ \approx \sqrt{2} erfinv ( E [ sgn ( {λ}_{FP {1}_{k}} ) ] ) - \sqrt{2} erfinv ( E [ sgn ( {λ}_{FP {0}_{k}} ) ] ) .\end{matrix}$$

A first-order partial derivative v_{p,k}=∂λₖ/∂cₚ may be calculated and stored in a memory element, M, constructing a Jacobian matrix V as defined as:

$$V = [ \begin{matrix}{v}_{1 , 1} & {v}_{1 , 2} & … & {v}_{1 , N - 1} & {v}_{1 , N} \\ {v}_{2 , 1} & {v}_{2 , 2} & & {v}_{2 , N - 1} & {v}_{2 , N} \\ ⋮ & & ⋱ & ⋮ & \\ {v}_{p , 1} & {v}_{p , 2} & … & {v}_{p , N - 1} & {v}_{p , N}\end{matrix} ] ,$$

where v_{p,k} is the first order partial derivative of the k-th residual ISI value λₖ with respect to the p-th control parameter cₚ, as expressed as:

$${v}_{p , k} = \frac{\partial {λ}_{k}}{\partial {c}_{p}} .$$

In the normal mode, the small deviation ∂cₚ may not be injected on the control parameters \vec{c}, the sign of residual ISI vector sgn( [symbol] ) or its average E[sgn( [symbol] )] may be observed without deviation, and V is kept constant in the memory element. The Jacobian matrix V may be used as an adaptation matrix W. Then, the sign of residual ISI vector sgn( [symbol] ) or its average E[sgn( [symbol] )] may be multiplied with W and loop constant −K, and −KW×sgn( [symbol] ) or its average −KW×E[sgn( [symbol] )] may be integrated to generate the control parameters \vec{c}. In at least some embodiments, the adaptive control system 900 may not characterize the Jacobian matrix V for every iteration, because V may be relatively constant for a small update to the control parameters \vec{c}.

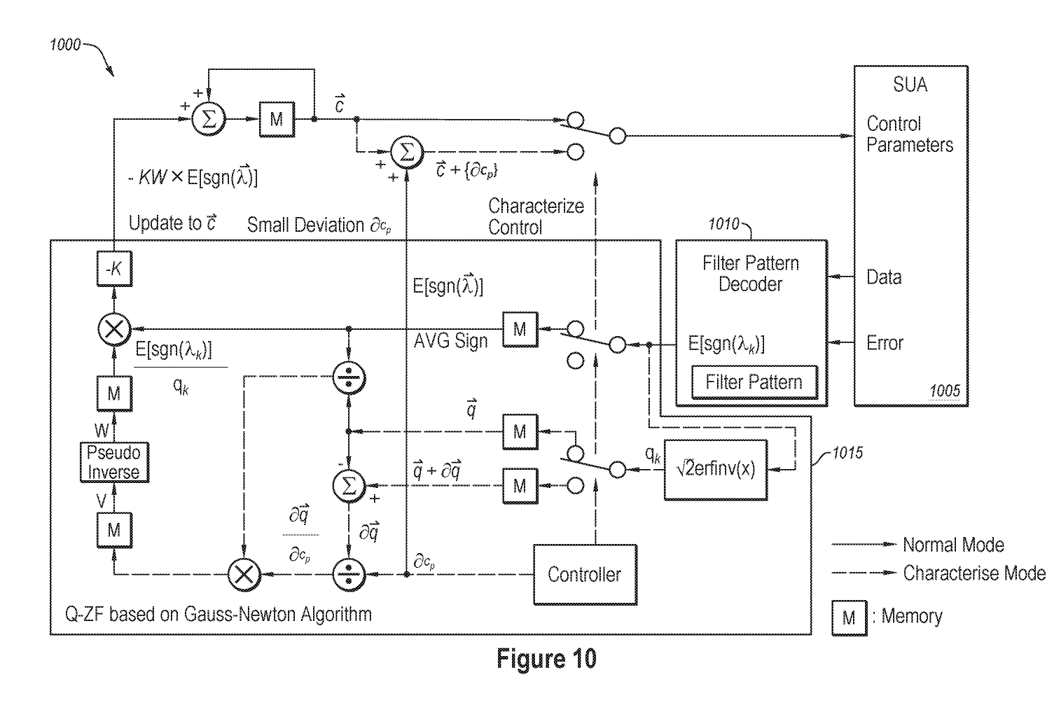

FIG. 10 illustrates a block diagram of an example adaptive control system 1000 that may use a Gauss-Newton algorithm with Q-ZF adaptive control. The adaptive control system 1000 may include a system under adaptation (SUA) 1005. The adaptive control system 1000 may provide control parameters (e.g., a vector represented as \vec{c}) to the SUA 1005 and the SUA 1005 may output data and error. The adaptive control system 1000 may operate similarly to the adaptive control system 900 of FIG. 9 except the pseudo inverse matrix of the Jacobian Matrix V may be used as an adaptation matrix W. In one embodiment, the pseudo inverse matrix of V may be calculated as W=(VV^{T})⁻¹V, where V^{T} is a transposed matrix of V, provided that VV^{T} is invertible (i.e. not singular). In another embodiment, when V is decomposed into V=USR^{T} using singular value decomposition where U and R are unitary matrices and S is a rectangular diagonal matrix of the same size as V with non-negative singular values as diagonal values, the pseudo inverse matrix of V may be calculated as W=UΣR^{T} where Σ is a rectangular diagonal matrix of the same size as V with inverse of corresponding positive singular values of S or zero for corresponding zero singular values of S as diagonal values.

In the normal mode, the small deviation ∂cₚ may not be injected on the control parameters \vec{c}, the sign of residual ISI vector sgn( [symbol] ) or its average E[sgn( [symbol] )] may be observed without deviation, and the adaptation matrix W is kept constant in the memory element. Then, the sign of residual ISI vector sgn( [symbol] ) or its average E[sgn( [symbol] )] may be multiplied with the adaptation matrix W and loop constant −K, and −KW×sgn( [symbol] ) or its average −KW×E[sgn( [symbol] )] may be integrated to generate the control parameters \vec{c}. In at least some embodiments, the adaptive control system 1000 may not characterize the Jacobian matrix V for every iteration, because V may be relatively constant for a small update to the control parameters \vec{c}.

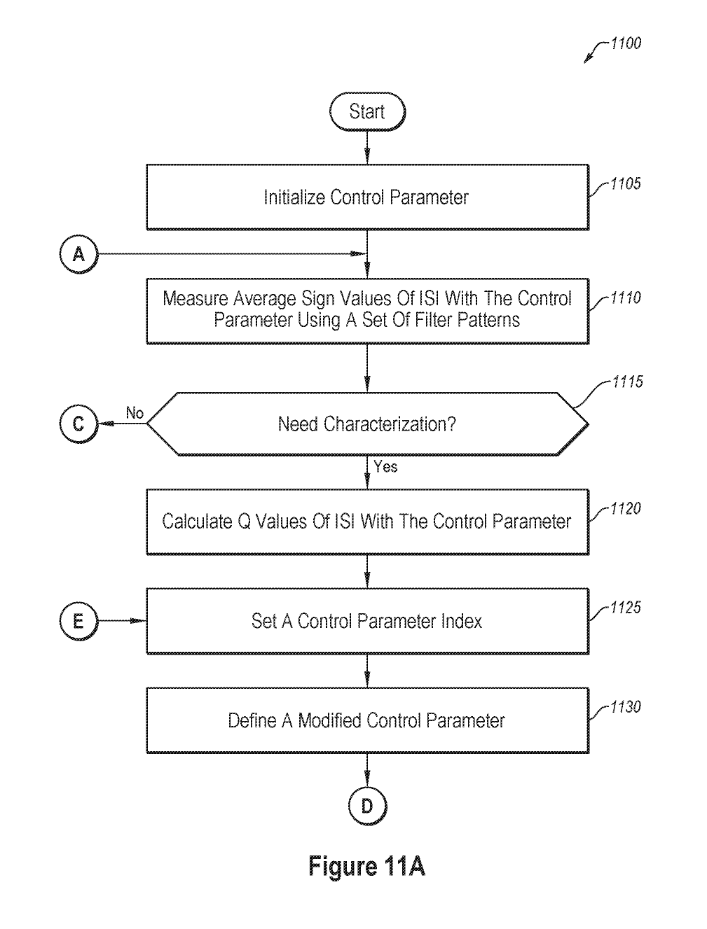

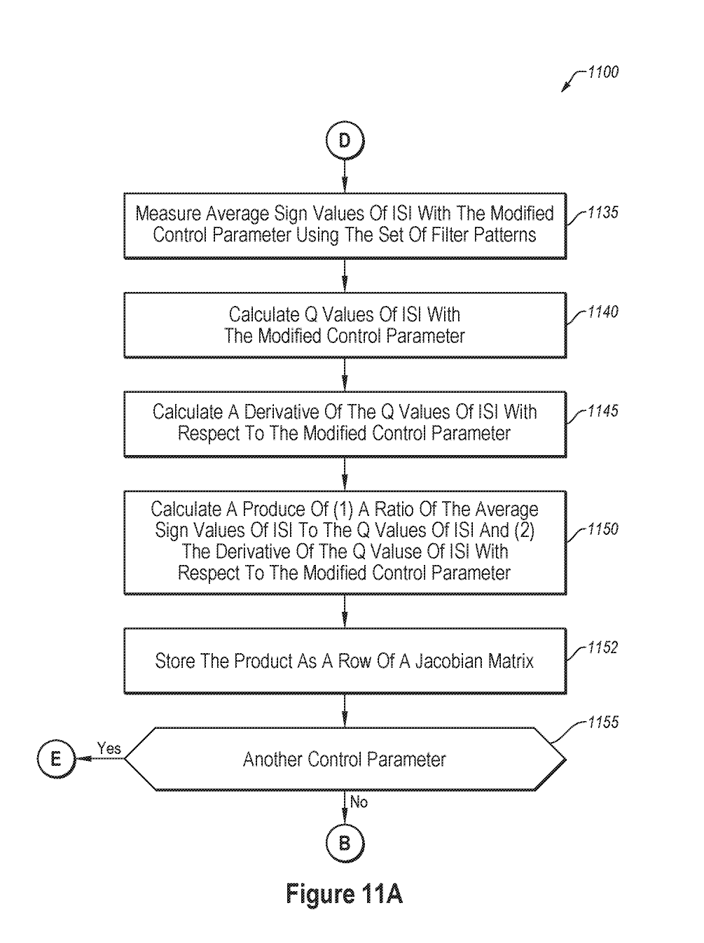

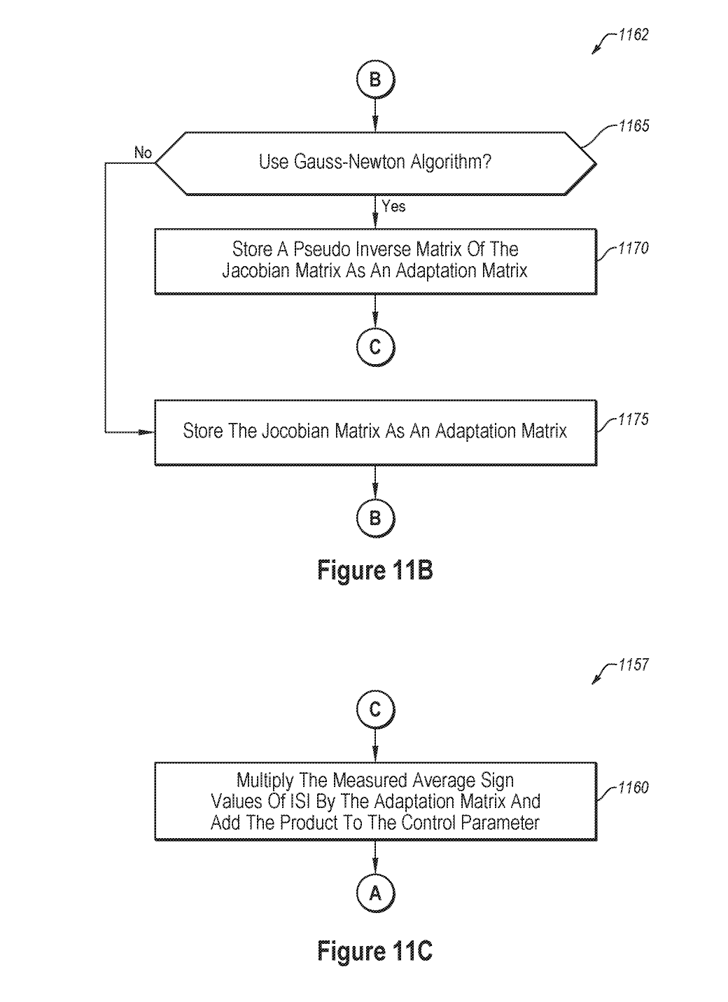

FIGS. 11A-C illustrates a flow diagram of a method 1100 of Q-based zero-forcing adaptive control. The method 1100 may be performed by processing logic that may include hardware (circuitry, dedicated logic, etc.), software (such as is run on a general purpose computer system or a dedicated machine), or a combination of both, which processing logic may be included in the adaptive equalizer control system 100 or another computer system or device. For simplicity of explanation, methods described herein are depicted and described as a series of acts. However, acts in accordance with this disclosure may occur in various orders and/or concurrently, and with other acts not presented and described herein. Further, not all illustrated acts may be required to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

In FIG. 11A, at block 1105, the processing logic may initialize one or more control parameters. In at least one embodiment, the control parameters may include multiple values that may be represented as a vector, [symbol] .

At block 1110, the processing logic may measure average sign values (e.g., +1, −1) of ISI in a data sequence with the control parameters [symbol] using a set of filter patterns. As an example, the average sign values of ISI E[sgn(λₖ)] may be measured using two filter patterns, FP1ₖ and FP0ₖ. The processing logic may measure the average sign values of ISI E[sgn(λₖ)] with [symbol] as the difference of average sign values of aggregate ISI between the two filter patterns FP1ₖ and FP0ₖ, where FP1ₖ and FP0ₖ are similar but differentiated for the ISI to be measured as follows:

E[sgn(λₖ)]=E[sgn(λ_{FP1}_{ₖ})]−E[sgn(λ_{FP0}_{ₖ})].

In a normal mode (i.e., not characterize mode), the above equation may be modified with measurement of a single sign value of ISI alternatively for FP1ₖ and FP0ₖ, which may have the same effect as average in a long term and may be represented as:

sgn(λₖ)=sgn(λ_{FP1}_{ₖ})

sgn(λₖ)=−sgn(λ_{FP0}_{ₖ}).

At block 1115, the processing logic may determine whether the processing logic is to characterize the control parameters [symbol] . When a normal mode is enabled (e.g., “NO” at block 1115), the processing logic may determine to not characterize the control parameters [symbol] and may proceed to block 1160 (e.g., via reference C), as further described in conjunction with FIG. 11C.

When a characterize mode is enabled (e.g., “YES” at block 1115), the processing logic may determine to characterize the control parameters [symbol] and may proceed to block 1120. At block 1120, the processing logic may calculate Q values of ISI with the control parameters [symbol] . In at least some embodiments, the processing logic may calculate the Q values of ISI with the control parameters [symbol] as [symbol] using the inverse error function, such as in the equation [symbol] =\sqrt{2}erfinv(E[sgn(\vec{λ})]). In at least some embodiments, the processing logic may calculate the Q values of ISI with the control parameters [symbol] as the difference of Q values of average sign values of aggregate ISI between two filter patterns FP1ₖ and FP0ₖ using the inverse error function for each of FP1ₖ and FP0ₖ, which may use the equation:

qₖ=\sqrt{2}erfinv(E[sgn(λ_{FP1}_{ₖ})])−\sqrt{2}erfinv(E[sgn(λ_{FP0}_{ₖ})]).

At block 1125, the processing logic may set a control parameter index p. The control parameter index p may be used to individually index each control parameter cₚ in the control parameters vector [symbol] , where each control parameter, cₚ, may be associated with a different index identifier, where p=1, 2, 3, . . . , n, and where n is the number of control parameters in the control parameters vector [symbol] .

At block 1130, the processing logic may define a modified control parameter, which may be represented as [symbol] +{∂cₚ}. In at least some embodiments, the processing logic may temporarily inject a small deviation to control parameter cₚ as [symbol] +{∂cₚ} where {∂cₚ} is ∂cₚ for the control parameter with index p and zero for all other indices.

At block 1135, the processing logic may measure average sign values of ISI with the modified control parameter using the set of filter patterns. In at least some embodiments, the processing logic may measure average sign values of ISI with [symbol] +{∂cₚ} as E[sgn( [symbol] + [symbol] )] using filter patterns and/or extended filter patterns. For example, the average sign values of ISI with [symbol] +{∂cₚ} may be measured as the difference between two filter patterns FP1ₖ and FP0ₖ, which may be represented as:

E[sgn(λₖ+∂λₖ)]=E[sgn(λ_{FP1}_{ₖ}+∂λ_{FP1}_{ₖ})]−E[sgn(λ_{FP0}_{ₖ}+∂λ_{FP0}_{ₖ})].

At block 1140, the processing logic may calculate Q values of ISI with the modified control parameter. In at least some embodiments, the processing logic may calculate the Q values of ISI with [symbol] +{∂cₚ} as [symbol] + [symbol] =\sqrt{2}erfinv(E[sgn(\vec{λ}+∂\vec{λ})]) using the inverse error function. For example, the Q values of ISI with [symbol] +{∂cₚ} may be calculated as the difference of Q values of average sign values of aggregate ISI between two filter patterns FP1ₖ and FP0ₖ using the inverse error function for each of FP1ₖ and FP0ₖ, which may be represented as:

$${q}_{k} + \partial {q}_{k} = \sqrt{2} erfinv ( E [ sgn ( {λ}_{FP {1}_{k}} + \partial {λ}_{FP {1}_{k}} ) ] ) - \sqrt{2} erfinv ( E [ sgn ( {λ}_{FP {0}_{k}} + \partial {λ}_{FP {0}_{k}} ) ] ) .$$

At block 1145, the processing logic may calculate a derivative of the Q values of ISI with respect to the modified control parameter cₚ. In at least some embodiments, the processing logic may calculate a first-order derivative of the Q values of ISI at \vec{c} with respect to the modified control parameter cₚ as:

$$\frac{\partial \vec{q}}{\partial {c}_{p}} = \frac{( \vec{q} + \partial \vec{q} ) - \vec{q}}{\partial {c}_{p}} .$$

At block 1150, a ratio of the average sign values of ISI to the Q values of ISI may be calculated as a ratio of the difference of average sign values of aggregate ISI between two filter patterns FP1ₖ and FP0ₖ to the Q values of ISI, which may be represented as:

$$\frac{E [ sgn ( {λ}_{k} ) ]}{{q}_{k}} = \frac{E [ sgn ( {λ}_{FP {1}_{k}} ) ] - E [ sgn ( {λ}_{FP {0}_{k}} ) ]}{{q}_{k}} .$$

The processing logic may calculate a product of the ratio of the average sign values of ISI to the Q values of ISI and the derivative of the Q values of ISI with respect to the modified control parameter cₚ. In at least some embodiments, the processing logic may use the first-order derivative of the Q values of ISI at \vec{c} with respect to the modified control parameter cₚ when calculating the product of the ratio of the average sign values of ISI to the Q values of ISI and the derivative of the Q values of ISI with respect to the modified control parameter cₚ.

At block 1152, the processing unit may store the product as a row of a Jacobian matrix. In at least some embodiments, the processing logic may store the product as a p-th row of Jacobian matrix V, which may be represented as:

$${( V )}_{p , k} = \frac{E [ sgn ( {λ}_{k} ) ]}{{q}_{k}} ( \frac{\partial {q}_{k}}{\partial {c}_{p}} ) for k ∈ \{ 1 , 2 , … , N \} ,$$

where N is the number of measured ISI.

At block 1155, the processing logic may determine whether another control parameter (e.g., cₚ₊₁) in the control parameters [symbol] is to be characterized. When another control parameter (e.g., cₚ₊₁) in the control parameters [symbol] is to be characterized (e.g., “YES” at block 1155), the processing logic may loop to block 1125, where the processing logic may use another indexed control parameter in blocks 1125-1155.

When no other control parameters in the control parameters [symbol] are to be characterized (e.g., “NO” at block 1155), the processing logic may advance via reference B to block 1165 of FIG. 11B.

In FIG. 11B, at block 1165, which may be reached via reference B, the processing logic may determine whether the Q-based zero-forcing adaptive control is set to use the Gauss-Newton algorithm.

When the Q-based zero-forcing adaptive control is set to use the Gauss-Newton algorithm (e.g., “YES” at block 1165), at block 1170 the processing logic may store a pseudo inverse matrix of the Jacobian matrix V as an adaptation matrix W. In one embodiment, the pseudo inverse matrix of V may be calculated as W=(VV^{T})⁻¹V, where V^{T} is a transposed matrix of V, provided that VV^{T} is invertible (i.e. not singular). In another embodiment, when V is decomposed into V=USR^{T} using singular value decomposition where U and R are unitary matrices and S is a rectangular diagonal matrix of the same size as V with non-negative singular values as diagonal values, the pseudo inverse matrix of V may be calculated as W=UΣR^{T} where Σ is a rectangular diagonal matrix of the same size as V with inverse of corresponding positive singular values of S or zero for corresponding zero singular values of S as diagonal values.

After block 1170, the processing logic may proceed via reference C to block 1160 of FIG. 11C.

When the Q-based zero-forcing adaptive control is not set to use the Gauss-Newton algorithm (e.g., “NO” at block 1165), the processing logic may be configured to use a different algorithm. For example, the processing logic may be configured to use a Gradient-Descent algorithm, where an adaptation matrix W may be the Jacobian matrix V. At block 1175, the processing logic may store the Jacobian matrix V as an adaptation matrix W. After block 1175, the processing logic may proceed via reference C to block 1160 of FIG. 11C.

In FIG. 11C, at block 1160, which may be reached via reference C, the processing logic may multiply the measured averaged sign values of ISI by the adaptation matrix and may add the product of the multiplication to the control parameters [symbol] . In at least some embodiments, the processing logic may multiply the measured average sign values of ISI E[sgn( [symbol] )] with −KW, where W is the adaptation matrix and K is a small positive loop constant. When adding the product of the multiplication to the control parameters [symbol] , the processing logic may use the equation:

[symbol]

= [symbol] −KW×E[sgn( [symbol] )].

After block 1160, the processing logic may proceed via reference A to block 1110 of FIG. 11A.

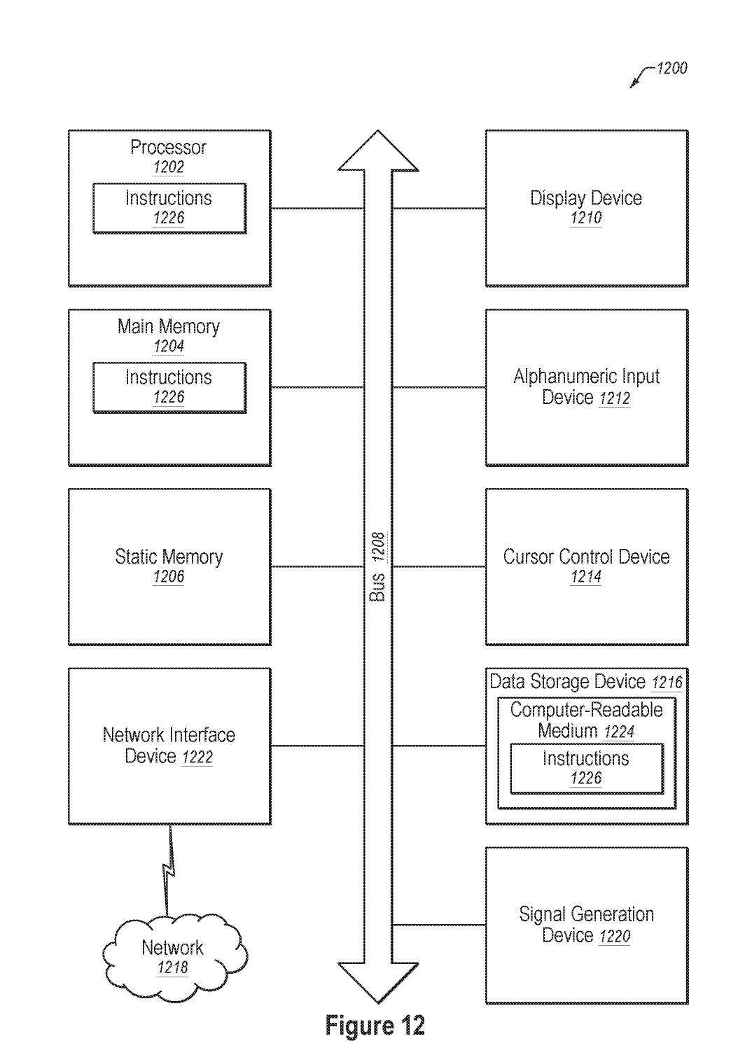

FIG. 12 illustrates a block diagram of an example computer system 1200 of adaptive equalizer control, according to at least one embodiment of the present disclosure. The adaptive control system 100 of FIG. 1 may be implemented as a computing system such as the example computer system 1200. The computer system 1200 may be configured to implement one or more operations of the present disclosure.

The computer system 1200 executes one or more sets of instructions 1226 that cause the machine to perform any one or more of the methodologies discussed herein. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a mobile telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute the sets of instructions 1226 to perform any one or more of the methodologies discussed herein.

The computer system 1200 includes a processor 1202, a main memory 1204 (e.g., read-only memory (ROM), flash memory, dynamic random access memory (DRAM) such as synchronous DRAM (SDRAM) or Rambus DRAM (RDRAM), etc.), a static memory 1206 (e.g., flash memory, static random access memory (SRAM), etc.), and a data storage device 1216, which communicate with each other via a bus 1208.

The processor 1202 represents one or more general-purpose processing devices such as a microprocessor, central processing unit, or the like. More particularly, the processor 1202 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1202 may also be one or more special-purpose processing devices such as an application specific integrated circuit (ASIC), a field programmable gate array (FPGA), a digital signal processor (DSP), network processor, or the like. The processor 1202 is configured to execute instructions for performing the operations and steps discussed herein.

The computer system 1200 may further include a network interface device 1222 that provides communication with other machines over a network 1218, such as a local area network (LAN), an intranet, an extranet, or the Internet. The network interface device 1222 may include any number of physical or logical interfaces. The network interface device 1222 may include any device, system, component, or collection of components configured to allow or facilitate communication between network components in a network. For example, the network interface device 1222 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a WiFi device, a WiMax device, cellular communication facilities, etc.), and/or the like. The network interface device 1222 may permit data to be exchanged with a network (such as a cellular network, a WiFi network, a MAN, an optical network, etc., to name a few examples) and/or any other devices described in the present disclosure, including remote devices. In at least one embodiment, the network interface device 1222 may be logical distinctions on a single physical component, for example, multiple communication streams across a single physical cable or optical signal.

The computer system 1200 also may include a display device 1210 (e.g., a liquid crystal display (LCD) or a cathode ray tube (CRT)), an alphanumeric input device 1212 (e.g., a keyboard), a cursor control device 1214 (e.g., a mouse), and a signal generation device 1220 (e.g., a speaker).

The data storage device 1216 may include a computer-readable medium 1224 on which is stored the sets of instructions 1226 embodying any one or more of the methodologies or functions described herein. The sets of instructions 1226 may also reside, completely or at least partially, within the main memory 1204 and/or within the processor 1202 during execution thereof by the computer system 1200, the main memory 1204 and the processor 1202 also constituting computer-readable storage media. The sets of instructions 1226 may further be transmitted or received over the network 1218 via the network interface device 1222.

While the example of the computer-readable storage medium 1224 is shown as a single medium, the term “computer-readable storage medium” may include a single medium or multiple media (e.g., a centralized or distributed database, and/or associated caches and servers) that store the sets of instructions 1226. The term “computer-readable storage medium” may include any medium that is capable of storing, encoding or carrying out a set of instructions for execution by the machine and that cause the machine to perform any one or more of the methodologies of the present disclosure. The term “computer-readable storage medium” may include, but not be limited to, solid-state memories, optical media, and magnetic media.

In an example embodiment, a device may include a memory and a processing system operatively coupled to the memory. The processing system may be configured to measure a first set of average sign values of inter-symbol interference (ISI) with an initial control parameter, determine a first Q value based on the first set of average sign values and the initial control parameter, define a modified control parameter based on the initial control parameter, measure a second set of average sign values of ISI with the modified control parameter, determine a second Q value based on the second set of average sign values and the modified control parameter, determine a difference between the first Q value and the second Q value, and equalize an output based on the difference between the first Q value and the second Q value. The first Q value may include a ratio of a measured inter-symbol interference (“IR”) to a measured noise. When determining the first Q value based on the first set of average sign values and the initial control parameter, the processing system may be configured to calculate a first inverse error function of a set of sign values of the measured ISI. The set of sign values may be expressed with the equation: E[sgn(λₖ)]≈erf(λₖ/\sqrt{2σ²}), where λₖ may include an analog value of the measured ISI, sgn(λₖ) may include a sign function, E[sgn(λₖ)] may include an expected value of sgn(λₖ), σ may include a standard deviation of measurement noise due to minor ISI, and erf(sgn(λₖ)) may include an error function of sgn(λₖ). The first Q value may be determined using the equation: qₖ=λₖ/σ≈\sqrt{2}erfinv(E[sgn(λₖ)]), where qₖ is the first Q value. The first Q value may be determined based on calculating a difference of a third Q value that was calculated and a fourth Q value that was calculated.

Modifications, additions, or omissions may be made to the computer system 1200 without departing from the scope of the present disclosure. For example, in at least one embodiment, the computer system 1200 may include any number of other components that may not be explicitly illustrated or described.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In at least one embodiment, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” may be interpreted as “including, but not limited to,” the term “having” may be interpreted as “having at least,” the term “includes” may be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases may not be construed to imply that the introduction of a claim recitation by the indefinite articles “a” or “an” limits any particular claim containing such introduced claim recitation to embodiments containing only one such recitation, even when the same claim includes the phrases “one or more” or “at least one” and indefinite articles such as “a” or “an” (e.g., “an introductory” and/or “an” may be interpreted to mean “at least one” or “one or more”); the same holds true for the use of definite articles used to introduce claim recitations.

In addition, even if a specific number of an introduced claim recitation is explicitly recited, those skilled in the art will recognize that such recitation may be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, may be understood to contemplate the possibilities of including one of the terms, either of the terms, or both terms. For example, the phrase “A or B” may be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations may be made hereto without departing from the spirit and scope of the present disclosure.

1. A method of adaptive equalizer control, the method comprising:
measuring a first set of average sign values of a first set of inter-symbol interference (ISI) of an output signal with a set of control parameters using correlation;
determining a first set of Q values based on the first set of average sign values of the first set of ISI, wherein the first set of Q values includes a ratio of the first set of ISI to a noise;
adjusting the set of control parameters based on the first set of Q values; and
adjusting, by an equalizer, the output signal based on the set of control parameters by applying at least one of a gain or an offset to the output signal to reduce the first set of ISI of the output signal.

2. (canceled)

3. The method of claim 1, wherein determining the first set of Q values based on the first set of average sign values comprises calculating a first set of inverse error functions of the first set of average sign values of the first set of ISI.

4. The method of claim 3, wherein the first set of average sign values is expressed with the equation: E[sgn(λₖ)]≈erf(λₖ/\sqrt{2σ²}), wherein k is an index number in the first set of average sign values, λₖ is an analog value of the measured ISI, sgn(λₖ) is a sign function of λₖ, E[sgn(λₖ)] is an expected value of sgn(λₖ), σ is a standard deviation of noise, and erf(sgn(λₖ)) is an error function of sgn(λₖ).

5. The method of claim 4, wherein the first set of Q values is determined using the equation:
qₖ=λₖ/σ≈\sqrt{2}erfinv(E[sgn(λₖ)]),
wherein qₖ is the first set of Q values.

6. The method of claim 1 further comprising:
measuring a second set of average sign values of a second set of ISI of the output signal with the set of control parameters using inverted correlation;
determining a second set of Q values based on the second set of average sign values of the second set of ISI; and
adjusting the set of control parameters is based on a difference between the first set of Q values and the second set of Q values.

7. The method of claim 6, wherein the difference between the first set of Q values and the second set of Q values is based on a difference between (a) the first set of inverse error functions of the first set of average sign values of the first set of ISI and (b) a second set of inverse error functions of the second set of average sign values of the second set of ISI.

8. A non-transitory computer-readable medium containing instructions that, when executed by a processor, are configured to cause the processor to perform operations, the operations comprising:
measure a first set of average sign values of a first set of inter-symbol interference (ISI) of an output signal with a set of control parameters using correlation;
determine a first set of Q values based on the first set of average sign values of the first set of ISI, wherein the first set of Q values includes a ratio of the first set of ISI to a noise;
adjust the set of control parameters based on the first set of Q values; and
adjust the output signal based on the set of control parameters by applying at least one of a gain or an offset to the output signal to reduce the first set of ISI of the output signal.

9. (canceled)

10. The non-transitory computer-readable medium of claim 8, wherein determining the first set of Q values based on the first set of average sign values comprises calculating a first set of inverse error functions of the first set of average sign values of the first set of ISI.

11. The non-transitory computer-readable medium of claim 10, wherein
the first set of average sign values is expressed with the equation: E[sgn(λₖ)]≈erf(λₖ/\sqrt{2σ²}), wherein k is an index number in the first set of average sign values, λₖ is an analog value of the measured ISI, sgn(λₖ) is a sign function of λₖ, E[sgn(λₖ)] is an expected value of sgn(λₖ), σ is a standard deviation of noise, and erf(sgn(λₖ)) is an error function of sgn(λₖ).

12. The non-transitory computer-readable medium of claim 11, wherein the first set of Q values is determined using the equation:
qₖ=λₖ/σ≈\sqrt{2}erfinv(E[sgn(λₖ)]),
wherein qₖ is the first set of Q values.

13. The non-transitory computer-readable medium of claim 8, the operations further comprising:
measure a second set of average sign values of a second set of ISI of the output signal with the set of control parameters using inverted correlation;
determine a second set of Q values based on the second set of average sign values of the second set of ISI; and
adjust the set of control parameters is based on a difference between the first set of Q values and the second set of Q values.

14. The non-transitory computer-readable medium of claim 13, wherein the difference between the first set of Q values and the second set of Q values is based on a difference between (a) the first set of inverse error functions of the first set of average sign values of the first set of ISI and (b) a second set of inverse error functions of the second set of average sign values of the second set of ISI.

15. A device comprising:
a memory, and
a processor operatively coupled to the memory, the processor being configured to:
measure a first set of average sign values of a first set of inter-symbol interference (ISI) of an output signal with a set of control parameters using correlation;
determine a first set of Q values based on the first set of average sign values of the first set of ISI, wherein the first set of Q values includes a ratio of the first set of ISI to a noise;
adjust the set of control parameters based on the first set of Q values; and
adjust the output signal based on the set of control parameters by applying at least one of a gain or an offset to the output signal to reduce the first set of ISI of the output signal.

16. (canceled)

17. The device of claim 15, wherein determining the first set of Q values based on the first set of average sign values comprises calculating a first set of inverse error functions of the first set of average sign values of the first set of ISI.

18. The device of claim 17, wherein the first set of average sign values is expressed with the equation: E[sgn(λₖ)]≈erf(λₖ/\sqrt{2σ²}), wherein k is an index number in the first set of average sign values, λₖ is an analog value of the measured ISI, sgn(λₖ) is a sign function of λₖ, E[sgn(λₖ)] is an expected value of sgn(λₖ), σ is a standard deviation of noise, and erf(sgn(λₖ)) is an error function of sgn(λₖ).

19. The device of claim 18, wherein the first set of Q values is determined using the equation:
qₖ=λₖ/σ≈\sqrt{2}erfinv(E[sgn(λₖ)]),
wherein qₖ is the first set of Q values.

20. The device of claim 15, wherein the processing system is further configured to:
measure a second set of average sign values of a second set of ISI of the output signal with the set of control parameters using inverted correlation;
determine a second set of Q values based on the second set of average sign values of the second set of ISI; and
adjust the set of control parameters is based on a difference between the first set of Q values and the second set of Q values.
